(19) United States
(12) Patent Application Publication
(10) Pub. No.: US 2016/0086405 A1
(43) Pub. Date: Mar. 24, 2016

(54) INFORMATION PROCESSING METHODS, ELECTRONIC DEVICES AND WEARABLE ELECTROINC DEVICES

(71) Applicants: Beijing Lenovo Software Ltd., Beijing (CN); Lenovo (Beijing) Limited, Beijing (CN)

(72) Inventors: Bin Yang, Beijing (CN); Guoyong Sun, Beijing (CN); Xiaohai Zhang, Beijing (CN)

(21) Appl. No.: 14/633,490

(22) Filed: Feb. 27, 2015

(30) Foreign Application Priority Data
Sep. 19, 2014 (CN) 201410484262.X
Dec. 17, 2014 (CN) 201410788848.5

(51) Int. Cl. G07C 9/00

(52) U.S. Cl. CPC G07C 9/00158; G07C 9/00087

(57) ABSTRACT

The disclosure provides an information processing method, an electronic device and a wearable electronic device. The information processing method comprises: obtaining a first physiological parameter at a user's first part by using a first wearable electronic device; generating a first identification code corresponding to the first physiological parameter; acquiring a second identification code transmitted from a second wearable electronic device which communicates with the first wearable electronic device; judging whether the first identification code matches the second identification code, to obtain a judgment result; and establishing a connection between the first wearable electronic device and the second wearable electronic device, if the judgment result indicates that the first identification code matches the second identification code.

### PRIORITY APPLICATIONS

This application claims the benefit under 35 U.S.C. 119 to Chinese Application No. 201410484262.X, filed on 19 Sep. 2014 and to Chinese Application No. 201410788848.5, filed on 17 December 14; which applications are incorporated herein by reference in their entirety.

### TECHNICAL FIELD

The disclosure generally relates to the information processing technology, and particularly, to information processing methods, electronic devices and wearable electronic devices.

### BACKGROUND

With the continuing development of science and technology, smart electronic devices, such as smart phones, tablet computers, smart watches, smart glasses, etc., have gained ever-increasing popularity. Particularly, the advent of wearable electronic devices (such as smart glasses, smart bracelets, smart watches, etc.) brings significant improvements to our life. Normally, a user has several smart electronic devices which are able to perform cooperative communications. Among others, a hot topic in this field is how to improve the performance and efficiency of connections among different smart electronic devices and to facilitate interaction among them.

When implementing technical solutions according to embodiments of the disclosure, the inventors of the application find that, regarding the above topic, the following technical problems exist in prior art.

First, when wearable electronic devices are used, the selection of the wearable electronic devices and the establishment of connections among the wearable electronic devices are accomplished mainly through human-machine interaction. This process is complicated, thereby drastically reducing the convenience brought by wearable electronic devices to our modern life and also degrading the user experience.

Also after the user's multiple electronic devices have established connections therebetween and can perform cooperative communications, one of the multiple electronic devices, which receives to-be-output information (for example, a phone receives a call and needs to display information about the call, such as the phone number of the caller, the home location of the caller, etc.), However, one or more of the phones, tablet computers, smart watches and smart glasses may now be in an idle state (for example a standby state), a do-not-disturb state (for example, an online gaming state or an online video state) or a difficult-to-reach state (for example, far away from the user or in the user's pocket). If the electronic device is in the do-not-disturb state, performing an output operation at the electronic device would cause an interruption of some of the electronic device's online applications. If the electronic device is in the difficult-to-reach state, although the output operation is performed and the information is output, the user does not know the content of the output information because he/she cannot easily reach the electronic device. Therefore, in the prior art exists the following technical problem: in various scenarios, it is often impossible to appropriately transmit the to-be-output information to proper electronic devices for output. In addition, due to this technical problem, the optimal user experience may not be obtained when the user uses the prior art electronic devices to output information.

### SUMMARY

According to a first aspect of the disclosure, there is provided an information processing method applicable to a first wearable electronic device. The first wearable electronic device is able to maintain a first relative positional relationship with a first part of a user. The information processing method comprises:

obtaining a first physiological parameter at the first part of the user by using the first wearable electronic device;

generating a first identification code corresponding to the first physiological parameter;

acquiring a second identification code transmitted from a second wearable electronic device which communicates with the first wearable electronic device;

judging whether the first identification code matches the second identification code, to obtain a judgment result;

establishing a connection between the first wearable electronic device and the second wearable electronic device, if the judgment result indicates that the first identification code matches the second identification code.

Optionally, the acquiring the second identification code transmitted from the second wearable electronic device may comprise:

acquiring the second identification code generated according to a second physiological parameter, wherein the second physiological parameter is obtained by the second wearable electronic device at the second part of the user.

Optionally, the method may further comprise:

presetting a physiological parameter database storing at least one physiological parameter of N users, where N≧1.

Accordingly, the judging whether the first identification code matches the second identification code may comprise:
judging, according to the physiological parameter database, whether the first physiological parameter corresponding to the first identification code and the second physiological parameter corresponding to the second identification code are from the same user, to obtain a judgment result; and
determining that the first identification code matches the second identification code, if the judgment result indicates that the first physiological parameter corresponding to the first identification code and the second physiological parameter corresponding to the second identification code are from the same user.

Optionally, the method may further comprise:

presetting a physiological parameter database storing at least one physiological parameter of N users, where N≧1.

Accordingly, the judging whether the first identification code matches the second identification code comprises:
judging, according to the physiological parameter database, whether the first physiological parameter corresponding to the first identification code and the second physiological parameter corresponding to the second identification code are stored in the physiological parameter database, to obtain a judgment result; and
determining that the first identification code matches the second identification code, if the judgment result indicates that the first physiological parameter corresponding to the first identification code and the second physiological parameter corresponding to the second identification code are stored in the physiological parameter database.

Optionally, the method may further comprise: after generating the first identification code corresponding to the first physiological parameter,
broadcasting a signal including the first identification code so that the second wearable electronic device can receive the first identification code via wireless communications.

Optionally, the signal may further include request information for requesting establishment of a connection to the second electronic device.

According to a second aspect of the disclosure, there is provided a wearable electronic device that is able to perform information interaction with at least one wearable electronic device including a second wearable electronic device. The wearable electronic device is able to maintain a first relative positional relationship with a first part of a user, and the second wearable electronic device is able to maintain a second relative positional relationship with a second part of the user. The wearable electronic device comprises:

an obtaining unit configured to obtain a first physiological parameter at the first part of the user;

a generating unit configured to generate a first identification code corresponding to the first physiological parameter;

an acquiring unit configured to acquire a second identification code transmitted from the second wearable electronic device;

a judging unit configured to judge whether the first identification code matches the second identification code, to obtain a judgment result;

an establishing unit configured to establish a connection between the wearable electronic device and the second wearable electronic device if the judgment result indicates that the first identification code matches the second identification code.

Optionally, the acquiring unit may be configured to acquire the second identification code generated according to a second physiological parameter, wherein the second physiological parameter is obtained by the second wearable electronic device at the second part of the user.

Optionally, the wearable electronic device may further comprise:

a setting unit configured to preset a physiological parameter database storing at least one physiological parameter of N users, where N≧1.

Accordingly, the judging unit comprises:
a first judging subunit configured to judge, according to the physiological parameter database, whether the first physiological parameter corresponding to the first identification code and the second physiological parameter corresponding to the second identification code are from the same user, to obtain a judgment result; and
a first determining subunit configured to determine that the first identification code matches the second identification code, if the judgment result indicates that the first physiological parameter corresponding to the first identification code and the second physiological parameter corresponding to the second identification code are from the same user.

Optionally, the wearable electronic device may further comprise:

a setting unit configured to preset a physiological parameter database storing at least one physiological parameter of N users, where N≧1.

Accordingly, the judging unit may comprise:
a second judging subunit configured to judge, according to the physiological parameter database, whether the first physiological parameter corresponding to the first identification code and the second physiological parameter corresponding to the second identification code are stored in the physiological parameter database, to obtain a judgment result; and
a second determining subunit configured to determine that the first identification code matches the second identification code, if the judgment result indicates that the first physiological parameter corresponding to the first identification code and the second physiological parameter corresponding to the second identification code are stored in the physiological parameter database.

Optionally, the wearable electronic device may further comprise:

a broadcasting unit configured to broadcast a signal including the first identification code so that the second wearable electronic device can receive the first identification code via wireless communications.

Optionally, the signal may further include request information for requesting establishment of a connection to the second electronic device.

In view of the above aspects, in technical solutions according to embodiments of the disclosure, the wearable electronic device is enabled to obtain a physiological parameter of a user (for example, a smart watch can obtain a pulse rate at its user's wrist), and then generate a unique identification code corresponding to the physiological parameter. Subsequently, the wearable electronic device detects, according to its identification code, identification codes of other wearable electronic devices, and establishes connections with the other wearable electronic device whose identification codes match the wearable electronic device's identification code. In this manner, the embodiments of the disclosure enable a wearable electronic device to automatically connect to various wearable electronic devices according to a user's physiological parameter obtained by the wearable electronic device, thereby reducing human-machine interaction and improving user experience.

According to a third aspect of the disclosure, there is provided an information processing method applicable to a first electronic device that is able to cooperatively communicate with M second electronic devices, where M is an integer greater than or equal to 1. The method comprises:

acquiring to-be-output information;

determining a matching electronic device among the first electronic device and the M second electronic devices which communicate with the first wearable electronic device, so that the to-be-output information can be output by the matching electronic device.

Optionally, the method may further comprise: after acquiring the to-be-output information,

detecting information attribute parameters of the to-be-output information, wherein the information attribute parameters include at least one of a first application parameter of a first application for outputting the to-be-output information, an amount of storage space occupied by the to-be-output information, an output size of the to-be-output information and an amount of power consumption for the to-be-output information;

detecting N state parameters which include a first state parameter of the first electronic device and M second state parameters corresponding to the M second electronic devices, where N is a positive integer equal to M+1,

wherein an i^{th} state parameter among the N state parameters is a state parameter of an i^{th} electronic device among N electronic devices including the first electronic device and the M second electronic devices, and includes combination of one or more of the following: at least one application parameter in the i^{th} electronic device, an i^{th} current environment parameter of the i^{th} electronic device and an i^{th} device-inherent parameter of the i^{th} electronic device, where i is any integer between 1 and N.

Optionally, the determining the matching electronic device which satisfies the preset condition, among the first electronic device and the M second electronic devices, so that the to-be-output information can be output by the determined electronic device may comprise:

judging, based on the i^{th} state parameter and the information attribute parameters, whether the i^{th} electronic device satisfies the preset condition, to obtain a first judgment result;

determining the i^{th} electric device as the matching electronic device so that the to-be-output information can be output by the i^{th} electronic device, if the first judgment result is affirmative.

Optionally, in case the i^{th} state parameter is combination of the at least one application parameter, the judging, based on the i^{th} state parameter and the information attribute parameters, whether the i^{th} electronic device satisfies the preset condition to obtain the first judgment result may comprise:

judging, based on the first application parameter and the at least one application parameter, whether the i^{th} electronic device satisfies a preset application condition, to obtain a second judgment result, wherein

if the second judgment result is affirmative, the second judgment result is the first judgment result indicating that the i^{th} electronic device satisfies the preset condition.

Optionally, the judging, based on the first application parameter and the at least one application parameter, whether the i^{th} electronic device satisfies the preset application condition to obtain the second judgment result may comprise:

obtaining a currently running application in the i^{th} electronic device based on the at least one application parameter;

judging, based on the at least one application parameter and the first application parameter, whether the i^{th} electronic device has the first application installed therein, to obtain a third judgment result;

judging whether the currently running application is an interruptible application, to obtain a fourth judgment result, when the third judgment result is affirmative, wherein

if the fourth judgment result is affirmative, the fourth judgment result is the second judgment result indicating that the i^{th} electronic device satisfies the preset application condition.

Optionally, the method may further comprise: after judging whether the currently running application is an interruptible application, to obtain a fourth judgment result when the third judgment result is affirmative,

judging whether the first application is an application that requires connecting to a network in order to be in a normal running state, to obtain a fifth judgment result, when the fourth judgment result is negative, wherein

if the fifth judgment result is negative, the fifth judgment result is the second judgment result indicating that the i^{th} electronic device satisfies the preset application condition; and when the fifth judgment result is affirmative, it indicates that the i^{th} electronic device does not satisfy the preset application condition.

Optionally, in case the i^{th} state parameter is combination of the at least one application parameter and the i^{th} current environment parameter, the judging, based on the i^{th} state parameter and the information attribute parameters, whether the i^{th} electronic device satisfies the preset condition to obtain the first judgment result may comprise:

judging, based on the first application parameter and the at least one application parameter, whether the i^{th} electronic device satisfies a preset application condition, to obtain a second judgment result;

judging, based on the i^{th} current environment parameter, whether the i^{th} electronic device satisfies a preset environment condition, to obtain a sixth judgment result;

judging, based on the second and the sixth judgment results, whether the i^{th} electronic device satisfies the preset condition, to obtain the first judgment result, wherein

if both the second and the sixth judgment results are affirmative, the first judgment result is affirmative indicating that the i^{th} electronic device satisfies the preset condition.

Optionally, the judging, based on the i^{th} current environment parameter, whether the i^{th} electronic device satisfies the preset environment condition to obtain the sixth judgment result may comprise:

obtaining a first distance between the i^{th} electronic device and its user and a first light intensity in an environment where the i^{th} electronic device exists, based on the i^{th} environment parameter;

judging whether the first distance is shorter than a first preset distance, to obtain a seventh judgment result;

judging whether the first light intensity is higher than a first preset light intensity, to obtain an eighth judgment result;

judging, based on the seventh and the eighth judgment results, whether the i^{th} electronic device satisfies the preset environment condition, to obtain the sixth judgment result, wherein

if both the seventh and the eighth judgment results are affirmative, the sixth judgment result is affirmative indicating that the i^{th} electronic device satisfies the preset environment condition.

Optionally, in case the i^{th} state parameter is combination of the at least one application parameter, the i^{th} current environment parameter and the i^{th} device-inherent parameter, the judging, based on the i^{th} state parameter and the information attribute parameters, whether the i^{th} electronic device satisfies the preset condition to obtain the first judgment result may comprise:

judging, based on the first application parameter and the at least one application parameter, whether the i^{th} electronic device satisfies a preset application condition, to obtain a second judgment result;

judging, based on the i^{th} current environment parameter, whether the i^{th} electronic device satisfies a preset environment condition, to obtain a sixth judgment result;

judging, based on the i^{th} device-inherent parameter and the information attribute parameters, whether the i^{th} electronic device satisfies a preset inherent attribute condition, to obtain a ninth judgment result;

judging, based on the second, the sixth and the ninth judgment results, whether the i^{th} electronic device satisfies the preset condition, to obtain the first judgment result, wherein

if all the second, the sixth and the ninth judgment results are affirmative, the first judgment result is affirmative indicating that the i^{th} electronic device satisfies the preset condition.

Optionally, the judging, based on the i^{th} device-inherent parameter and the attribute parameters, whether the i^{th} electronic device satisfies the preset inherent attribute condition to obtain the ninth judgment result may comprise:

obtaining a current power quantity, an amount of remaining buffer space and a size of an output unit of the i^{th} electronic device, based on the i^{th} device-inherent parameter;

judging whether the current power quantity is higher than the amount of power consumption, to obtain a tenth judgment result;

judging whether the amount of the remaining buffer space is larger than the amount of the occupied storage space, to obtain an eleventh judgment result;

judging whether the size of the output unit is larger than the output size, to obtain a twelfth judgment result;

judging, based on the tenth, the eleventh and the twelfth judgment results, whether the i^{th} electronic device satisfies the preset inherent attribute condition, to obtain the ninth judgment result, wherein

if all the tenth, the eleventh and the twelfth judgment results are affirmative, the ninth judgment result is affirmative indicating that the i^{th} electronic device satisfies the preset inherent attribute condition.

Optionally, the method may further comprise: after determining the matching electronic device which satisfies the preset condition, among the first electronic device and the M second electronic devices, so that the to-be-output information can be output by the matching electronic device,

judging whether the matching electronic device is a third electronic device different from the first electronic device, to obtain a thirteenth judgment result;

transmitting the to-be-output information to the third electronic device so that the to-be-output information can be output by the matching electronic device, when the thirteenth judgment result is affirmative.

According to a fourth aspect of the disclosure, there is provided a first electronic device that is able to cooperatively communicate with M second electronic devices, where M is an integer greater than or equal to 1. The first electronic device comprises:

a first acquiring unit configured to acquire to-be-output information;

a first determining unit configured to determine a matching electronic device among the first electronic device and the M second electronic devices which communicate with the first wearable electronic device, so that the to-be-output information can be output by the matching electronic device.

Optionally, the first electronic device may further comprise:

a first detecting unit configured to detect information attribute parameters of the to-be-output information, wherein the information attribute parameters include at least one of a first application parameter of a first application for outputting the to-be-output information, an amount of storage space occupied by the to-be-output information, an output size of the to-be-output information and an amount of power consumption for the to-be-output information;

a second detecting unit configured to detect N state parameters which include a first state parameter of the first electronic device and M second state parameters corresponding to the M second electronic devices, where N is a positive integer equal to M+1,

wherein an i^{th} state parameter among the N state parameters is a state parameter of an i^{th} electronic device among N electronic devices including the first electronic device and the M second electronic devices, and includes combination of one or more of the following: at least one application parameter in the i^{th} electronic device, an i^{th} current environment parameter of the i^{th} electronic device and an i^{th} device-inherent parameter of the i^{th} electronic device, where i is any integer between 1 and N.

Optionally, the first determining unit may comprise:

a first judging subunit configured to judge, based on the i^{th} state parameter and the information attribute parameters, whether the i^{th} electronic device satisfies the preset condition, to obtain a first judgment result;

a first determining subunit configured to determine the i^{th} electric device as the matching electronic device so that the to-be-output information can be output by the i^{th} electronic device, if the first judgment result is affirmative.

Optionally, in case the i^{th} state parameter is combination of the at least one application parameter, the first judging subunit may comprise:

a first judging module configured to judge, based on the first application parameter and the at least one application parameter, whether the i^{th} electronic device satisfies a preset application condition, to obtain a second judgment result, wherein

if the second judgment result is affirmative, the second judgment result is the first judgment result indicating that the i^{th} electronic device satisfies the preset condition.

Optionally, the first judging module may comprise:

a first obtaining submodule configured, to obtain a currently running application in the i^{th} electronic device based on the at least one application parameter;

a first judging submodule configured to judge, based on the at least one application parameter and the first application parameter, whether the i^{th} electronic device has the first application installed therein, to obtain a third judgment result;

a second judging submodule configured to judge whether the currently running application is an interruptible application, to obtain a fourth judgment result, when the third judgment result is affirmative, wherein

if the fourth judgment result is affirmative, the fourth judgment result is the second judgment result indicating that the i^{th} electronic device satisfies the preset application condition.

Optionally, the first judging module may further comprise:

a third judging submodule configured to judge whether the first application is an application that requires connecting to a network in order to be in a normal running state, to obtain a fifth judgment result, when the fourth judgment result is negative, wherein

if the fifth judgment result is negative, the fifth judgment result is the second judgment result indicating that the i^{th} electronic device satisfies the preset application condition; and when the fifth judgment result is affirmative, it indicates that the i^{th} electronic device does not satisfy the preset application condition.

Optionally, in case the i^{th} state parameter is combination of the at least one application parameter and the i^{th} current environment parameter, the first judging subunit may comprise:

a first judging module configured to judge, based on the first application parameter and the at least one application parameter, whether the i^{th} electronic device satisfies a preset application condition, to obtain a second judgment result;

a second judging module configured to judge, based on the i^{th} current environment parameter, whether the i^{th} electronic device satisfies a preset environment condition, to obtain a sixth judgment result;

a third judging module configured to judge, based on the second and the sixth judgment results, whether the i^{th} electronic device satisfies the preset condition, to obtain the first judgment result, wherein

if both the second and the sixth judgment results are affirmative, the first judgment result is affirmative indicating that the i^{th} electronic device satisfies the preset condition.

Optionally, the second judging module may comprise:

a second obtaining submodule configured, to obtain a first distance between the i^{th} electronic device and its user and a first light intensity in an environment where the i^{th} electronic device exists, based on the i^{th} environment parameter;

a fourth judging submodule configured to judge whether the first distance is shorter than a first preset distance, to obtain a seventh judgment result;

a fifth judging submodule configured to judge whether the first light intensity is higher than a first preset light intensity, to obtain an eighth judgment result;

a sixth judging submodule configured to judge, based on the seventh and the eighth judgment results, whether the i^{th} electronic device satisfies the preset environment condition, to obtain the sixth judgment result, wherein

if both the seventh and the eighth judgment results are affirmative, the sixth judgment result is affirmative indicating that the i^{th} electronic device satisfies the preset environment condition.

Optionally, in case the i^{th} state parameter is combination of the at least one application parameter, the i^{th} current environment parameter and the i^{th} device-inherent parameter, the first judging subunit may comprise:

a first judging module configured to judge, based on the first application parameter and the at least one application parameter, whether the i^{th} electronic device satisfies a preset application condition, to obtain a second judgment result;

a second judging module configured to judge, based on the i^{th} current environment parameter, whether the i^{th} electronic device satisfies a preset environment condition, to obtain a sixth judgment result;

a fourth judging module configured to judge, based on the i^{th} device-inherent parameter and the information attribute parameters, whether the i^{th} electronic device satisfies a preset inherent attribute condition, to obtain a ninth judgment result;

a fifth judging module configured to judge, based on the second, the sixth and the ninth judgment results, whether the i^{th} electronic device satisfies the preset condition, to obtain the first judgment result, wherein

when all the second, the sixth and the ninth judgment results are affirmative, the first judgment result is affirmative indicating that the i^{th} electronic device satisfies the preset condition.

Optionally, the fourth judging module may comprise:

a third obtaining submodule configured to obtain a current power quantity, an amount of remaining buffer space and a size of an output unit of the i^{th} electronic device, based on the i^{th} device-inherent parameter;

a seventh judging submodule configured to judge whether the current power quantity is higher than the amount of power consumption, to obtain a tenth judgment result;

an eighth judging submodule configured to judge whether the amount of the remaining buffer space is larger than the amount of the occupied storage space, to obtain an eleventh judgment result;

a ninth judging submodule configured to judge whether the size of the output unit is larger than the output size, to obtain a twelfth judgment result;

a tenth judging submodule configured to judge, based on the tenth, the eleventh and the twelfth judgment results, whether the i^{th} electronic device satisfies the preset inherent attribute condition, to obtain the ninth judgment result, wherein

when all the tenth, the eleventh and the twelfth judgment results are affirmative, the ninth judgment result is affirmative indicating that the i^{th} electronic device satisfies the preset inherent attribute condition.

Optionally, the first electronic device may further comprise:

a first judging unit configured to judge whether the matching electronic device is a third electronic device different from the first electronic device, to obtain a thirteenth judgment result;

a first transmitting unit configured to transmit the to-be-output information to the third electronic device so that the to-be-output information can be output by the matching electronic device, when the thirteenth judgment result is affirmative.

The electronic devices in the third and the fourth aspects of the disclosure include wearable electronic devices.

Optionally, the electronic devices in the third and the fourth aspects of the disclosure include the wearable electronic devices in the first and the second aspects of the disclosure.

The technical solutions according to the third and the fourth aspects of the disclosure at least have the following technical effects:

1. A matching electronic device which satisfies the preset condition is determined, among the first electronic device which receives to-be-output information and the M second electronic devices which cooperatively communicate with the first electronic device, for outputting the to-be-output information. As such, the first electronic device will not transmit the to-be-output information to those which are in a state unsuitable to output the to-be-output information. Accordingly, the prior art technical problem of being unable to transmit the to-be-output information to proper electronic devices for output can be effectively solved, and the technical effect of transmitting the to-be-output information to proper electronic devices is achieved.

2. in the above third and fourth aspects, technical means as judging, based on state parameters of the first electronic device and the M electronic devices and information attribute parameters of the to-be-output information, whether the electronic devices satisfy the preset condition for outputting the to-be-output information is adopted, therefore the first electronic device will not transmit the to-be-output information to one or more electronic devices among the M electronic devices which cooperatively communicate with the first electronic device, in case the one or more electronic devices are in the do-not-disturb state or the difficult-to-reach state (for example, the electronic devices are in the online gaming state or far away from the user). Accordingly, the user experience can be effectively improved.

### BRIEF DESCRIPTION OF THE DRAWINGS

FIG. 1 is a flowchart illustrating an information processing method according to a first embodiment of the disclosure;

FIG. 2 is a flowchart illustrating an information processing method according to a second embodiment of the disclosure;

FIG. 3 is a flowchart illustrating an information processing method according to a third embodiment of the disclosure;

FIG. 4 is a flowchart illustrating an information processing method according to a fourth embodiment of the disclosure;

FIG. 5 is a flowchart illustrating an information processing method according to a fifth embodiment of the disclosure;

FIG. 6 is a diagram illustrating a structure of a portable electronic device according to a first embodiment of the disclosure;

FIG. 7 is a diagram illustrating a structure of a portable electronic device according to a second embodiment of the disclosure;

FIG. 8 is a diagram illustrating a structure of a portable electronic device according to a third embodiment of the disclosure;

FIG. 9 is a diagram illustrating a structure of a portable electronic device according to a fourth embodiment of the disclosure;

FIG. 10 is a diagram illustrating a structure of a portable electronic device according to a fifth embodiment of the disclosure;

FIG. 11 is a flowchart illustrating an information processing method according to a sixth embodiment of the disclosure;

FIG. 12 is a flowchart illustrating step S104 in the information processing method according to a sixth embodiment of the disclosure;

FIG. 13 is a flowchart illustrating a first implementation of step S1042 in the information processing method according to a sixth embodiment of the disclosure;

FIG. 14 is a flowchart illustrating a second implementation of step S1042 in the information processing method according to a sixth embodiment of the disclosure;

FIG. 15 is a flowchart illustrating a third implementation of step S1042 in the information processing method according to a sixth embodiment of the disclosure; and

FIG. 16 is a block diagram illustrating a structure of a first electronic device according to a seventh embodiment of the disclosure.

### DETAILED DESCRIPTION OF EMBODIMENTS

In order to facilitate a thorough understanding of features and contents of embodiments of the disclosure, a detailed description will be given in conjunction with the accompanying drawings to explain how the embodiments of the disclosure are implemented. The drawings are given for reference and illustration rather than limiting the disclosure.

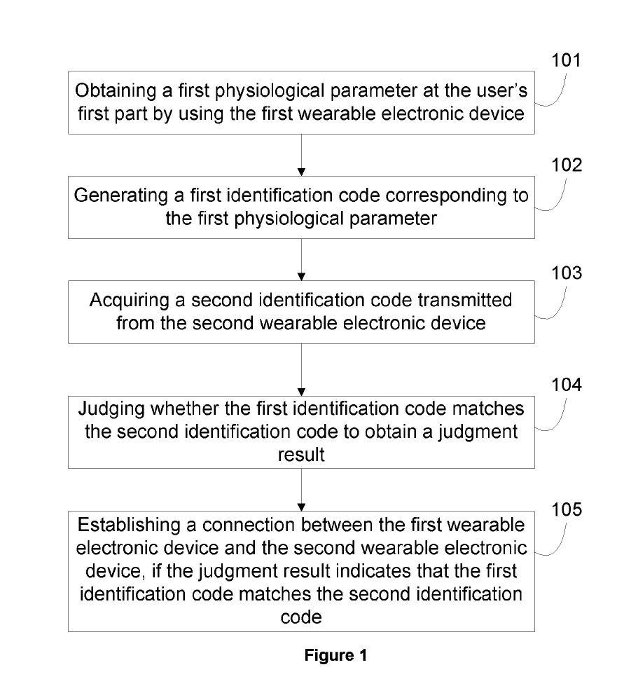

FIG. 1 is flowchart illustrating an information processing method according to a first embodiment of the disclosure. In this embodiment, the information method is applicable to a first wearable electronic device that is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. As shown in FIG. 1, the information processing method comprises the following steps.

At step 101, a first physiological parameter at the first part of the user is obtained by using the first wearable electronic device.

In the embodiment of the disclosure, any wearable electronic device other than the first wearable electronic device may be the second wearable electronic device. The first and the second electronic devices may be electronic devices that can be worn on the user, such as smart glasses, smart bracelets, smart watches, etc. When the first wearable electronic device is worn on the first part of the user, it can maintain a first relative positional relationship with the first part of the user. For example, when a smart watch is worn on the user's wrist, it can be fixed on the user's wrist by the watchband. Likewise, when the second wearable electronic device is worn on the second part of the user, it can maintain a second relative positional relationship with the second part of the user. Here, the first and the second wearable electronic devices may be worn on different parts of the same user or on the same part or different parts of different users. Therefore, the first and the second parts are not limited to the same part or different parts.

In the embodiment of the disclosure, the first and the second wearable electronic devices are each provided with an obtaining unit, by which a physiological parameter at a certain part of the user can be obtained. Specifically, the first wearable electronic device can obtain the first physiological parameter at the first part of the user, and the second wearable electronic device can obtain a second physiological parameter at the second part of the user. For example, when a smart watch is worn on the user's wrist, it can obtain a pulse rate at the user's wrist.

At step 102, a first identification code corresponding to the first physiological parameter is generated.

In the embodiment of the disclosure, for each physiological parameter, a unique identification code corresponding to the physiological parameter is generated. For example, the first physiological parameter corresponds to the first identification code, and the second physiological parameter corresponds to a second identification code. Here, the first and the second identification codes may be any combination of character strings, Chinese characters and the like. For example, the first identification code is MB120.

At step 103, a second identification code transmitted from the second wearable electronic device is acquired.

In the embodiment of the disclosure, after obtaining the second physiological parameter at the second part of the user, the second wearable electronic device generates the second identification code corresponding to the second physiological parameter. Then, the second identification code is broadcasted so that the first wearable electronic device can receive the second identification code via wireless communications. Meanwhile, after generating the first identification code corresponding to the first physiological parameter, the first wearable electronic device also broadcasts the first identification code so that the second wearable electronic device can receive the first identification code via wireless communications.

At step 104, it is judged whether the first identification code matches the second identification code, to obtain a judgment result.

In the embodiment of the disclosure, a matching rule is preset. Specifically, a physiological parameter database is preset, which stores at least one physiological parameter of N users, where N≧1. The preset matching rule is as follows: it is judged whether the first physiological parameter corresponding to the first identification code and the second physiological parameter corresponding to the second identification code are from the same user, to obtain a judgment result; and it is determine that the first identification code matches the second identification code, when the judgment result indicates that the first physiological parameter corresponding to the first identification code and the second physiological parameter corresponding to the second identification code are from the same user. Here, the first and the second physiological parameters may be of the same type or of different types. For example, the first and the second physiological parameters are pulse rate information obtained at different parts. As another example, the first physiological parameter is pulse rate information measured by a smart watch, while the second physiological parameter is iris information measured by a pair of smart glasses or fingerprint information measured by a smart phone. The physiological parameter database has all physiological parameters of a certain user recorded therein. According to the physiological parameter database, it can be learnt whether the first and the second physiological parameters are from the same user.

In the embodiment of the disclosure, the preset matching rule may also be as follows: it is judged whether the first physiological parameter corresponding to the first identification code and the second physiological parameter corresponding to the second identification code are stored in the physiological parameter database, to obtain a judgment result; and it is determined that the first identification code matches the second identification code, when the judgment result indicates that the first physiological parameter corresponding to the first identification code and the second physiological parameter corresponding to the second identification code are stored in the physiological parameter database. Here, the first and the second physiological parameters may also be of the same type or of different types. The physiological parameter database has physiological parameters of several persons recorded therein, allowing interconnection between these persons' wearable electronic devices. For example, when several persons find that all the physiological parameters characterizing their irises are stored in the physiological parameter database, their smart glasses may be interconnected and certain content may be shared and watched by these persons.

At step 105, a connection is established between the first wearable electronic device and the second wearable electronic device, when the judgment result indicates that the first identification code matches the second identification code.

In the embodiment of the disclosure, when the first identification matches the second identification code, the first wearable electronic device transmits to the second wearable electronic device a request for establishing a connection. Then, a connection is established between the first wearable electronic device and the second wearable electronic device. Alternatively, when the first wearable electronic device receives the identification code broadcasted by the second wearable electronic device, it also receives a request for establishing a connection carried by the broadcasted signal. Thus, after the first wearable electronic device judges that the second identification code matches the first identification code, it directly establishes a connection to the second wearable electronic device.

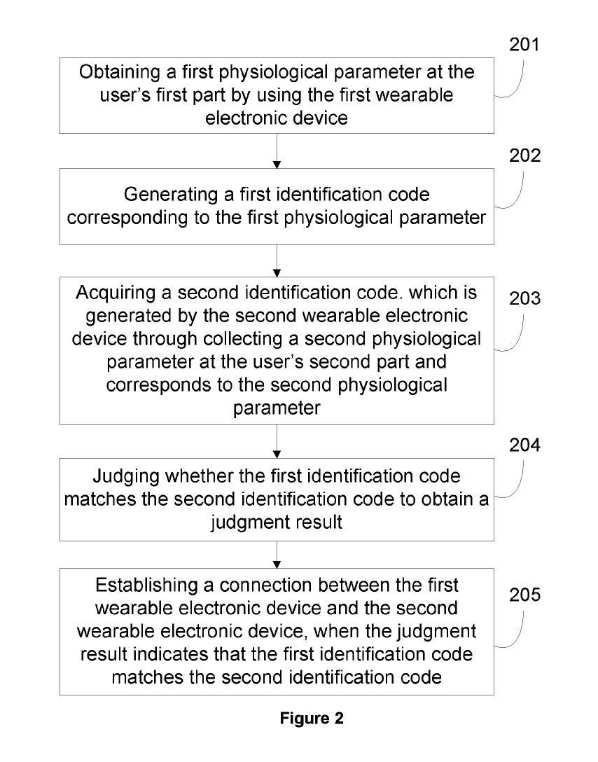

FIG. 2 is a flowchart illustrating an information processing method according to a second embodiment of the disclosure. In this embodiment, the information method is applicable to a first wearable electronic device that is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. As shown in FIG. 2, the information processing method comprises the following steps.

At step 201, a first physiological parameter at the first part of the user is obtained by using the first wearable electronic device.

In the embodiment of the disclosure, any wearable electronic device other than the first wearable electronic device is referred to as the second wearable electronic device. The first and the second electronic devices may be electronic devices that can be worn on the user, such as smart glasses, smart bracelets, smart watches, etc. When the first wearable electronic device is worn on the first part of the user, it can maintain a first relative positional relationship with the first part of the user. For example, when a smart watch is worn on the user's wrist, it can be fixed on the user's wrist by the watchband. Likewise, when the second wearable electronic device is worn on the second part of the user, it can maintain a second relative positional relationship with the second part of the user. Here, the first and the second wearable electronic devices may be worn on different parts of the same user or on the same part or different parts of different users. Therefore, the first and the second parts are not limited to the same part or different parts.

In the embodiment of the disclosure, the first and the second wearable electronic devices are each provided with an obtaining unit, by which a physiological parameter at a certain part of the user can be obtained. Specifically, the first wearable electronic device can obtain the first physiological parameter at the first part of the user, and the second wearable electronic device can obtain a second physiological parameter at the second part of the user. For example, when a smart watch is worn on the user's wrist, it can obtain a pulse rate at the user's wrist.

At step 202, a first identification code corresponding to the first physiological parameter is generated.

In the embodiment of the disclosure, for each physiological parameter, a unique identification code corresponding to the physiological parameter is generated. For example, the first physiological parameter corresponds to the first identification code, and the second physiological parameter corresponds to a second identification code. Here, the first and the second identification codes may be any combination of character strings, Chinese characters and the like. For example, the first identification code is MB120.

At step 203, a second identification code is acquired, which is generated by the second wearable electronic device through obtaining a second physiological parameter at the second part of the user and corresponds to the second physiological parameter.

In the embodiment of the disclosure, after obtaining the second physiological parameter at the second part of the user, the second wearable electronic device generates the second identification code corresponding to the second physiological parameter. Then, the second identification code is broadcasted so that the first wearable electronic device can receive the second identification code via wireless communications. Meanwhile, after generating the first identification code corresponding to the first physiological parameter, the first wearable electronic device also broadcasts the first identification code so that the second wearable electronic device can receive the first identification code via wireless communications.

At step 204, it is judged whether the first identification code matches the second identification code, to obtain a judgment result.

In the embodiment of the disclosure, a matching rule is preset. Specifically, a physiological parameter database is preset, which stores at least one physiological parameter of N users, where N≧1. The preset matching rule is as follows: it is judged whether the first physiological parameter corresponding to the first identification code and the second physiological parameter corresponding to the second identification code are from the same user, to obtain a judgment result; and it is determine that the first identification code matches the second identification code, when the judgment result indicates that the first physiological parameter corresponding to the first identification code and the second physiological parameter corresponding to the second identification code are from the same user. Here, the first and the second physiological parameters may be of the same type or of different types. For example, the first and the second physiological parameters are pulse rate information obtained at different parts. As another example, the first physiological parameter is pulse rate information measured by a smart watch, while the second physiological parameter is iris information measured by a smart glasses or fingerprint information measured by a smart phone. The physiological parameter database has all physiological parameters of a certain user recorded therein. According to the physiological parameter database, it can be learnt whether the first and the second physiological parameters are from the same user.

In the embodiment of the disclosure, the preset matching rule may also be as follows: it is judged whether the first physiological parameter corresponding to the first identification code and the second physiological parameter corresponding to the second identification code are stored in the physiological parameter database, to obtain a judgment result; and it is determined that the first identification code matches the second identification code, when the judgment result indicates that the first physiological parameter corresponding to the first identification code and the second physiological parameter corresponding to the second identification code are stored in the physiological parameter database. Here, the first and the second physiological parameters may also be of the same type or of different types. The physiological parameter database has physiological parameters of several persons recorded therein, allowing interconnection between these persons' wearable electronic devices. For example, when several persons find that all the physiological parameters characterizing their irises are stored in the physiological parameter database, their smart glasses may be interconnected and certain content may be shared and watched by these persons.

At step 205, a connection is established between the first wearable electronic device and the second wearable electronic device, when the judgment result indicates that the first identification code matches the second identification code.

In the embodiment of the disclosure, when the first identification matches the second identification code, the first wearable electronic device transmits to the second wearable electronic device a request for establishing a connection. Then, a connection is established between the first wearable electronic device and the second wearable electronic device. Alternatively, when the first wearable electronic device receives the identification code broadcasted by the second wearable electronic device, it also receives a request for establishing a connection carried by the broadcasted signal. Thus, after the first wearable electronic device judges that the second identification code matches the first identification code, it directly establishes a connection to the second wearable electronic device.

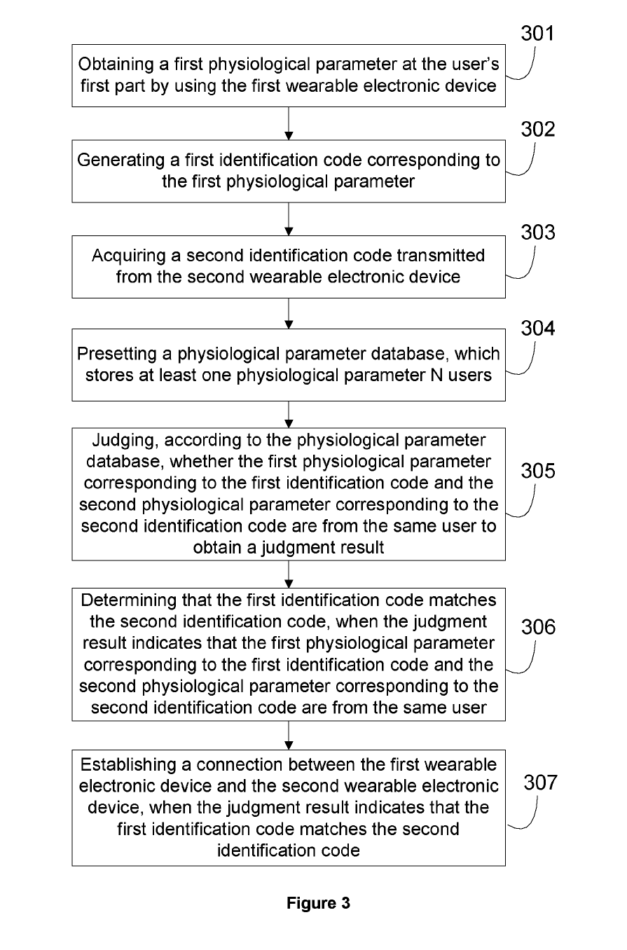

FIG. 3 is a flowchart illustrating an information processing method according to a third embodiment of the disclosure. In this embodiment, the information method is applicable to a first wearable electronic device that is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. As shown in FIG. 3, the information processing method comprises the following steps.

At step 301, a first physiological parameter at the first part of the user is obtained by using the first wearable electronic device.

In the embodiment of the disclosure, any wearable electronic device other than the first wearable electronic device is referred to as the second wearable electronic device. The first and the second electronic devices may be electronic devices that can be worn on the user, such as smart glasses, smart bracelets, smart watches, etc. When the first wearable electronic device is worn on the first part of the user, it can maintain a first relative positional relationship with the first part of the user. For example, when a smart watch is worn on the user's wrist, it can be fixed on the user's wrist by the watchband. Likewise, when the second wearable electronic device is worn on the second part of the user, it can maintain a second relative positional relationship with the second part of the user. Here, the first and the second wearable electronic devices may be worn on different parts of the same user or on the same part or different parts of different users. Therefore, the first and the second parts are not limited to the same part or different parts.

In the embodiment of the disclosure, the first and the second wearable electronic devices are each provided with an obtaining unit, by which a physiological parameter at a certain part of the user can be obtained. Specifically, the first wearable electronic device can obtain the first physiological parameter at the first part of the user, and the second wearable electronic device can obtain a second physiological parameter at the second part of the user. For example, when a smart watch is worn on the user's wrist, it can obtain a pulse rate at the user's wrist.

At step 302, a first identification code corresponding to the first physiological parameter is generated.

In the embodiment of the disclosure, for each physiological parameter, a unique identification code corresponding to the physiological parameter is generated. For example, the first physiological parameter corresponds to the first identification code, and the second physiological parameter corresponds to a second identification code. Here, the first and the second identification codes may be any combination of character strings, Chinese characters and the like. For example, the first identification code is MB120.

At step 303, a second identification code transmitted from the second wearable electronic device is acquired.

In the embodiment of the disclosure, after obtaining the second physiological parameter at the second part of the user, the second wearable electronic device generates the second identification code corresponding to the second physiological parameter. Then, the second identification code is broadcasted so that the first wearable electronic device can receive the second identification code via wireless communications. Meanwhile, after generating the first identification code corresponding to the first physiological parameter, the first wearable electronic device also broadcasts the first identification code so that the second wearable electronic device can receive the first identification code via wireless communications.

At step 304, a physiological parameter database is preset, which stores at least one physiological parameter of N users, where N≧1.

At step 305, it is judged, according to the physiological parameter database, whether the first physiological parameter corresponding to the first identification code and the second physiological parameter corresponding to the second identification code are from the same user, to obtain a judgment result.

At step 306, it is determined that the first identification code matches the second identification code, when the judgment result indicates that the first physiological parameter corresponding to the first identification code and the second physiological parameter corresponding to the second identification code are from the same user.

In the embodiment of the disclosure, a matching rule is preset. Specifically, a physiological parameter database is preset, which stores at least one physiological parameter of N users, where N≧1. The preset matching rule is as follows: it is judged whether the first physiological parameter corresponding to the first identification code and the second physiological parameter corresponding to the second identification code are from the same user, to obtain a judgment result; and it is determine that the first identification code matches the second identification code, when the judgment result indicates that the first physiological parameter corresponding to the first identification code and the second physiological parameter corresponding to the second identification code are from the same user. Here, the first and the second physiological parameters may be of the same type or of different types. For example, the first and the second physiological parameters are pulse rate information obtained at different parts. As another example, the first physiological parameter is pulse rate information measured by a smart watch, while the second physiological parameter is iris information measured by a smart glasses or fingerprint information measured by a smart phone. The physiological parameter database has all physiological parameters of a certain user recorded therein. According to the physiological parameter database, it can be learnt whether the first and the second physiological parameters are from the same user.

At step 307, a connection is established between the first wearable electronic device and the second wearable electronic device, when the judgment result indicates that the first identification code matches the second identification code.

In the embodiment of the disclosure, when the first identification matches the second identification code, the first wearable electronic device transmits to the second wearable electronic device a request for establishing a connection. Then, a connection is established between the first wearable electronic device and the second wearable electronic device. Alternatively, when the first wearable electronic device receives the identification code broadcasted by the second wearable electronic device, it also receives a request for establishing a connection carried by the broadcasted signal. Thus, after the first wearable electronic device judges that the second identification code matches the first identification code, it directly establishes a connection to the second wearable electronic device.

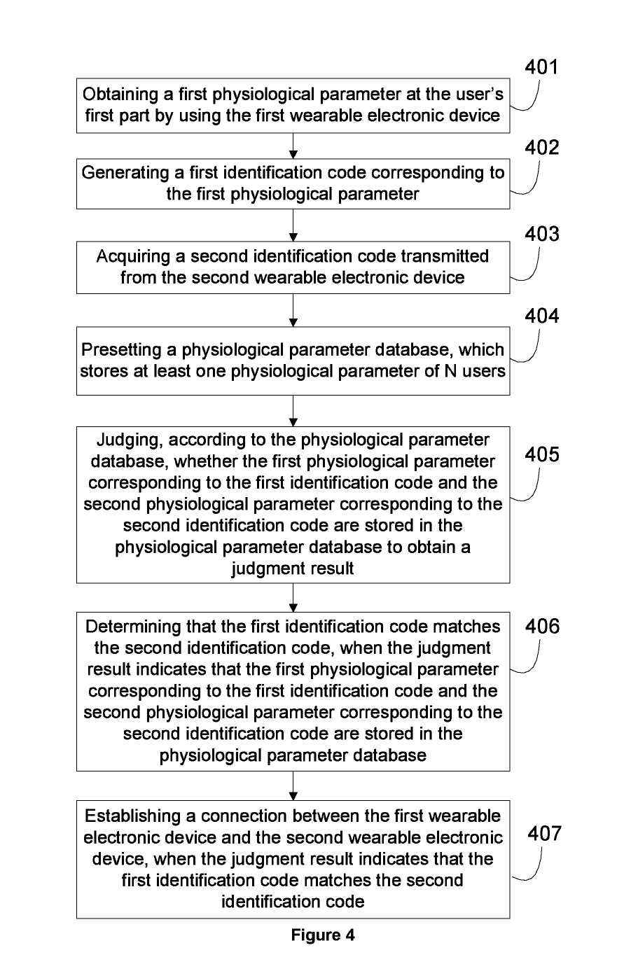

FIG. 4 is a flowchart illustrating an information processing method according to a fourth embodiment of the disclosure. In this embodiment, the information method is applicable to a first wearable electronic device that is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. As shown in FIG. 4, the information processing method comprises the following steps.

At step 401, a first physiological parameter at the first part of the user is obtained by using the first wearable electronic device.

In the embodiment of the disclosure, any wearable electronic device other than the first wearable electronic device is referred to as the second wearable electronic device. The first and the second electronic devices may be electronic devices that can be worn on the user, such as smart glasses, smart bracelets, smart watches, etc. When the first wearable electronic device is worn on the first part of the user, it can maintain a first relative positional relationship with the first part of the user. For example, when a smart watch is worn on the user's wrist, it can be fixed on the user's wrist by the watchband. Likewise, when the second wearable electronic device is worn on the second part of the user, it can maintain a second relative positional relationship with the second part of the user. Here, the first and the second wearable electronic devices may be worn on different parts of the same user or on the same part or different parts of different users. Therefore, the first and the second parts are not limited to the same part or different parts.

In the embodiment of the disclosure, the first and the second wearable electronic devices are each provided with an obtaining unit, by which a physiological parameter at a certain part of the user can be obtained. Specifically, the first wearable electronic device can obtain the first physiological parameter at the first part of the user, and the second wearable electronic device can obtain a second physiological parameter at the second part of the user. For example, when a smart watch is worn on the user's wrist, it can obtain a pulse rate at the user's wrist.

At step 402, a first identification code corresponding to the first physiological parameter is generated.

In the embodiment of the disclosure, for each physiological parameter, a unique identification code corresponding to the physiological parameter is generated. For example, the first physiological parameter corresponds to the first identification code, and the second physiological parameter corresponds to a second identification code. Here, the first and the second identification codes may be any combination of character strings, Chinese characters and the like. For example, the first identification code is MB120.

At step 403, a second identification code transmitted from the second wearable electronic device is acquired.

In the embodiment of the disclosure, after obtaining the second physiological parameter at the second part of the user, the second wearable electronic device generates the second identification code corresponding to the second physiological parameter. Then, the second identification code is broadcasted so that the first wearable electronic device can receive the second identification code via wireless communications. Meanwhile, after generating the first identification code corresponding to the first physiological parameter, the first wearable electronic device also broadcasts the first identification code so that the second wearable electronic device can receive the first identification code via wireless communications.

At step 404, a physiological parameter database is preset, which stores at least one physiological parameter of N users, where N≧1.

At step 405, it is judged, according to the physiological parameter database, whether the first physiological parameter corresponding to the first identification code and the second physiological parameter corresponding to the second identification code are stored in the physiological parameter database, to obtain a judgment result.

At step 406, it is determined that the first identification code matches the second identification code, when the judgment result indicates that the first physiological parameter corresponding to the first identification code and the second physiological parameter corresponding to the second identification code are stored in the physiological parameter database.

In the embodiment of the disclosure, a matching rule is preset. Specifically, a physiological parameter database is preset, which stores at least one physiological parameter of N users, where N≧1. The preset matching rule is as follows: it is judged whether the first physiological parameter corresponding to the first identification code and the second physiological parameter corresponding to the second identification code are stored in the physiological parameter database, to obtain a judgment result; and it is determined that the first identification code matches the second identification code, when the judgment result indicates that the first physiological parameter corresponding to the first identification code and the second physiological parameter corresponding to the second identification code are stored in the physiological parameter database. Here, the first and the second physiological parameters may also be of the same type or of different types. The physiological parameter database has physiological parameters of several persons recorded therein, allowing interconnection between these persons' wearable electronic devices. For example, when several persons find that all the physiological parameters characterizing their irises are stored in the physiological parameter database, their smart glasses may be interconnected and certain content may be shared and watched by these persons.

At step 407, a connection is established between the first wearable electronic device and the second wearable electronic device, when the judgment result indicates that the first identification code matches the second identification code.

In the embodiment of the disclosure, when the first identification matches the second identification code, the first wearable electronic device transmits to the second wearable electronic device a request for establishing a connection. Then, a connection is established between the first wearable electronic device and the second wearable electronic device. Alternatively, when the first wearable electronic device receives the identification code broadcasted by the second wearable electronic device, it also receives a request for establishing a connection carried by the broadcasted signal. Thus, after the first wearable electronic device judges that the second identification code matches the first identification code, it directly establishes a connection to the second wearable electronic device.

FIG. 5 is a flowchart illustrating an information processing method according to a fifth embodiment of the disclosure. In this embodiment, the information method is applicable to a first wearable electronic device that is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. As shown in FIG. 5, the information processing method comprises the following steps.

At step 501, a first physiological parameter at the first part of the user is obtained by using the first wearable electronic device.

In the embodiment of the disclosure, any wearable electronic device other than the first wearable electronic device is referred to as the second wearable electronic device. The first and the second electronic devices may be electronic devices that can be worn on the user, such as smart glasses, smart bracelets, smart watches, etc. When the first wearable electronic device is worn on the first part of the user, it can maintain a first relative positional relationship with the first part of the user. For example, when a smart watch is worn on the user's wrist, it can be fixed on the user's wrist by the watchband. Likewise, when the second wearable electronic device is worn on the second part of the user, it can maintain a second relative positional relationship with the second part of the user. Here, the first and the second wearable electronic devices may be worn on different parts of the same user or on the same part or different parts of different users. Therefore, the first and the second parts are not limited to the same part or different parts.

In the embodiment of the disclosure, the first and the second wearable electronic devices are each provided with an obtaining unit, by which a physiological parameter at a certain part of the user can be obtained. Specifically, the first wearable electronic device can obtain the first physiological parameter at the first part of the user, and the second wearable electronic device can obtain a second physiological parameter at the second part of the user. For example, when a smart watch is worn on the user's wrist, it can obtain a pulse rate at the user's wrist.

At step 502, a first identification code corresponding to the first physiological parameter is generated.

In the embodiment of the disclosure, for each physiological parameter, a unique identification code corresponding to the physiological parameter is generated. For example, the first physiological parameter corresponds to the first identification code, and the second physiological parameter corresponds to a second identification code. Here, the first and the second identification codes may be any combination of character strings, Chinese characters and the like. For example, the first identification code is MB120.

At step 503, a signal including the first identification code is broadcasted so that the second wearable electronic device can receive the first identification code via wireless communications.

In the embodiment of the disclosure, the signal further includes request information for requesting establishment of a connection to the second electronic device.

At step 504, a second identification code transmitted from the second wearable electronic device is acquired.

In the embodiment of the disclosure, after obtaining the second physiological parameter at the second part of the user, the second wearable electronic device generates the second identification code corresponding to the second physiological parameter. Then, the second identification code is broadcasted so that the first wearable electronic device can receive the second identification code via wireless communications. Meanwhile, after generating the first identification code corresponding to the first physiological parameter, the first wearable electronic device also broadcasts the first identification code so that the second wearable electronic device can receive the first identification code via wireless communications.

At step 505, it is judged whether the first identification code matches the second identification code, to obtain a judgment result.

In the embodiment of the disclosure, a matching rule is preset. Specifically, a physiological parameter database is preset, which stores at least one physiological parameter of N users, where N≧1. The preset matching rule is as follows: it is judged whether the first physiological parameter corresponding to the first identification code and the second physiological parameter corresponding to the second identification code are from the same user, to obtain a judgment result; and it is determine that the first identification code matches the second identification code, when the judgment result indicates that the first physiological parameter corresponding to the first identification code and the second physiological parameter corresponding to the second identification code are from the same user. Here, the first and the second physiological parameters may be of the same type or of different types. For example, the first and the second physiological parameters are pulse rate information obtained at different parts. As another example, the first physiological parameter is pulse rate information measured by a smart watch, while the second physiological parameter is iris information measured by a smart glasses or fingerprint information measured by a smart phone. The physiological parameter database has all physiological parameters of a certain user recorded therein. According to the physiological parameter database, it can be learnt whether the first and the second physiological parameters are from the same user.

In the embodiment of the disclosure, the preset matching rule may also be as follows: it is judged whether the first physiological parameter corresponding to the first identification code and the second physiological parameter corresponding to the second identification code are stored in the physiological parameter database, to obtain a judgment result; and it is determined that the first identification code matches the second identification code, when the judgment result indicates that the first physiological parameter corresponding to the first identification code and the second physiological parameter corresponding to the second identification code are stored in the physiological parameter database. Here, the first and the second physiological parameters may also be of the same type or of different types. The physiological parameter database has physiological parameters of several persons recorded therein, allowing interconnection between these persons' wearable electronic devices. For example, when several persons find that all the physiological parameters characterizing their irises are stored in the physiological parameter database, their smart glasses may be interconnected and certain content may be shared and watched by these persons.

At step 506, a connection is established between the first wearable electronic device and the second wearable electronic device, when the judgment result indicates that the first identification code matches the second identification code.

In the embodiment of the disclosure, when the first identification matches the second identification code, the first wearable electronic device transmits to the second wearable electronic device a request for establishing a connection. Then, a connection is established between the first wearable electronic device and the second wearable electronic device. Alternatively, when the first wearable electronic device receives the identification code broadcasted by the second wearable electronic device, it also receives a request for establishing a connection carried by the broadcasted signal. Thus, after the first wearable electronic device judges that the second identification code matches the first identification code, it directly establishes a connection to the second wearable electronic device.

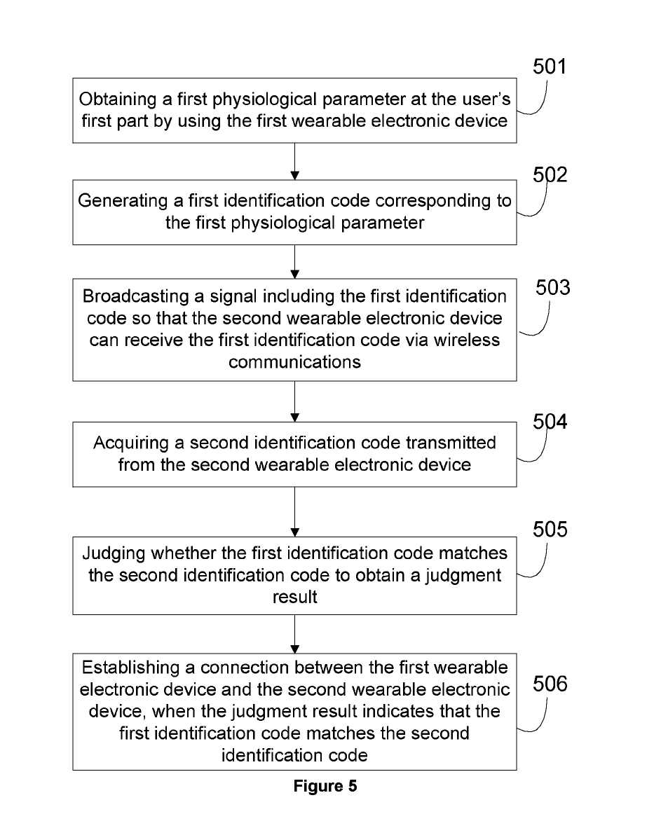

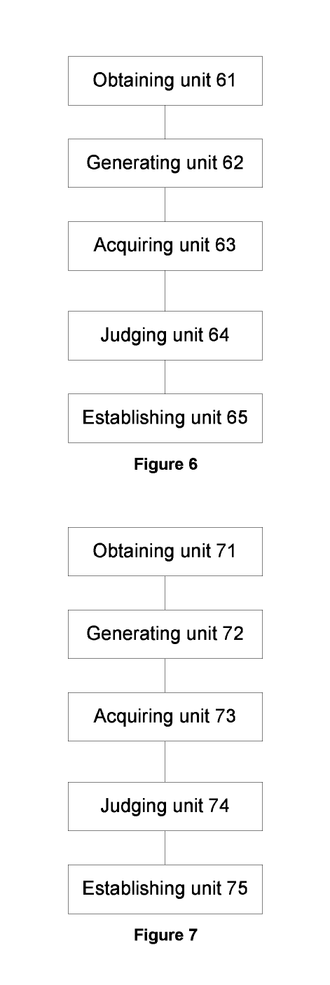

FIG. 6 is a diagram illustrating a structure of a wearable electronic device according to a first embodiment of the disclosure. In this embodiment, the wearable electronic device is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. The wearable electronic device comprises:

an obtaining unit 61 configured to obtain a first physiological parameter at the first part of the user;

a generating unit 62 configured to generate a first identification code corresponding to the first physiological parameter;

an acquiring unit 63 configured to acquire a second identification code transmitted from the second wearable electronic device;

a judging unit 64 configured to judge whether the first identification code matches the second identification code, to obtain a judgment result;

an establishing unit 65 configured to establish a connection between the wearable electronic device and the second wearable electronic device when the judgment result indicates that the first identification code matches the second identification code.

As those skilled in the art will appreciate, the functions of the processing units in the wearable electronic device according to the embodiment of the disclosure may be understood by referring to related description of the above-described information processing method. The processing units in the embodiment of the disclosure may be implemented by using analogous circuits that enable the functions described in the embodiment of the disclosure or by running software that enables the functions described in the embodiment of the disclosure on a smart device.

FIG. 7 is a diagram illustrating a structure of a wearable electronic device according to a second embodiment of the disclosure. In this embodiment, the wearable electronic device is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. The wearable electronic device comprises:

an obtaining unit 71 configured to obtain a first physiological parameter at the first part of the user;

a generating unit 72 configured to generate a first identification code corresponding to the first physiological parameter;

an acquiring unit 73 configured to acquire a second identification code transmitted from the second wearable electronic device;

a judging unit 74 configured to judge whether the first identification code matches the second identification code, to obtain a judgment result;

an establishing unit 75 configured to establish a connection between the wearable electronic device and the second wearable electronic device when the judgment result indicates that the first identification code matches the second identification code.

Preferably, the acquiring unit 73 is configured to acquire the second identification code, which is generated by the second wearable electronic device through obtaining a second physiological parameter at the second part of the user and corresponds to the second physiological parameter.

As those skilled in the art will appreciate, the functions of the processing units in the wearable electronic device according to the embodiment of the disclosure may be understood by referring to related description of the above-described information processing method. The processing units in the embodiment of the disclosure may be implemented by using analogous circuits that enable the functions described in the embodiment of the disclosure or by running software that enables the functions described in the embodiment of the disclosure on a smart device.

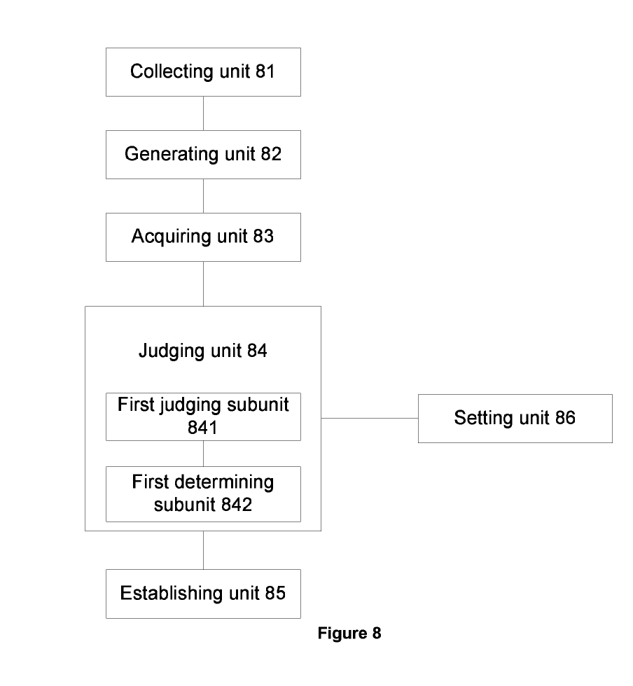

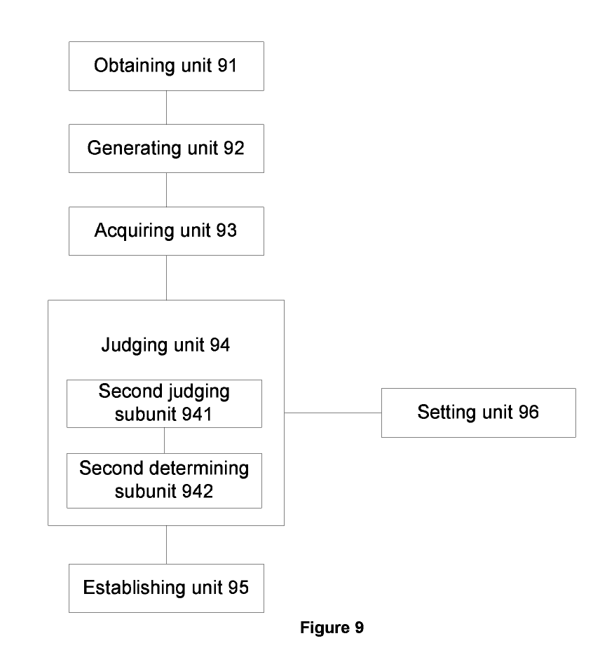

FIG. 8 is a diagram illustrating a structure of a wearable electronic device according to a third embodiment of the disclosure. In this embodiment, the wearable electronic device is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. The wearable electronic device comprises:

an obtaining unit 81 configured to obtain a first physiological parameter at the first part of the user;

a generating unit 82 configured to generate a first identification code corresponding to the first physiological parameter;

an acquiring unit 83 configured to acquire a second identification code transmitted from the second wearable electronic device;

a judging unit 84 configured to judge whether the first identification code matches the second identification code, to obtain a judgment result;

an establishing unit 85 configured to establish a connection between the wearable electronic device and the second wearable electronic device when the judgment result indicates that the first identification code matches the second identification code.

Preferably, the wearable electronic device further comprises:

a setting unit 86 configured to preset a physiological parameter database storing at least one physiological parameter of N users, where N≧1.

The judging unit 84 comprises:

a first judging subunit 841 configured to judge, according to the physiological parameter database, whether the first physiological parameter corresponding to the first identification code and the second physiological parameter corresponding to the second identification code are from the same user, to obtain a judgment result; and

a first determining subunit 842 configured to determine that the first identification code matches the second identification code, when the judgment result indicates that the first physiological parameter corresponding to the first identification code and the second physiological parameter corresponding to the second identification code are from the same user.

As those skilled in the art will appreciate, the functions of the processing units in the wearable electronic device according to the embodiment of the disclosure may be understood by referring to related description of the above-described information processing method. The processing units in the embodiment of the disclosure may be implemented by using analogous circuits that enable the functions described in the embodiment of the disclosure or by running software that enables the functions described in the embodiment of the disclosure on a smart device.

FIG. 9 is a diagram illustrating a structure of a wearable electronic device according to a fourth embodiment of the disclosure. In this embodiment, the wearable electronic device is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. The wearable electronic device comprises:

an obtaining unit 91 configured to obtain a first physiological parameter at the first part of the user;

a generating unit 92 configured to generate a first identification code corresponding to the first physiological parameter;

an acquiring unit 93 configured to acquire a second identification code transmitted from the second wearable electronic device;

a judging unit 94 configured to judge whether the first identification code matches the second identification code, to obtain a judgment result;

an establishing unit 95 configured to establish a connection between the wearable electronic device and the second wearable electronic device when the judgment result indicates that the first identification code matches the second identification code.

Preferably, the wearable electronic device further comprises:

a setting unit 96 configured to preset a physiological parameter database storing at least one physiological parameter of N users, where N≧1.

The judging unit 94 comprises:

a second judging subunit 941 configured to judge, according to the physiological parameter database, whether the first physiological parameter corresponding to the first identification code and the second physiological parameter corresponding to the second identification code are stored in the physiological parameter database, to obtain a judgment result; and

a second determining subunit 942 configured to determine that the first identification code matches the second identification code, when the judgment result indicates that the first physiological parameter corresponding to the first identification code and the second physiological parameter corresponding to the second identification code are stored in the physiological parameter database.

As those skilled in the art will appreciate, the functions of the processing units in the wearable electronic device according to the embodiment of the disclosure may be understood by referring to related description of the above-described information processing method. The processing units in the embodiment of the disclosure may be implemented by using analogous circuits that enable the functions described in the embodiment of the disclosure or by running software that enables the functions described in the embodiment of the disclosure on a smart device.

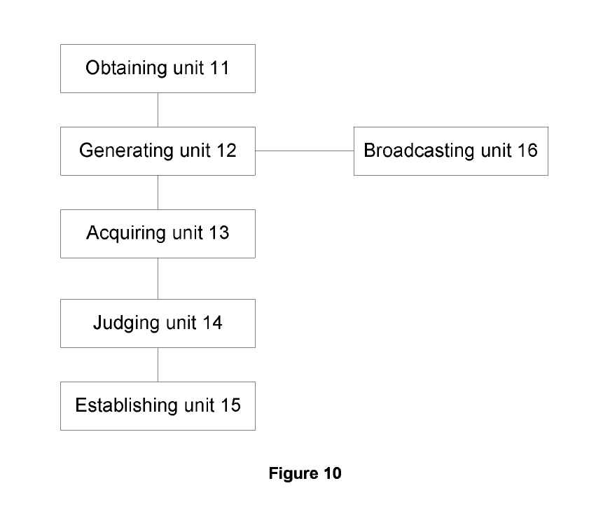

FIG. 10 is a diagram illustrating a structure of a wearable electronic device according to a fifth embodiment of the disclosure. In this embodiment, the wearable electronic device is able to perform information interaction with at least one wearable electronic device including a second wearable electronic device. The first wearable electronic device is able to maintain a first relative positional relationship with a first part of a user, and the second wearable electronic device is able to maintain a second relative positional relationship with a second part of the user. The wearable electronic device comprises:

an obtaining unit 11 configured to obtain a first physiological parameter at the first part of the user;

a generating unit 12 configured to generate a first identification code corresponding to the first physiological parameter;

an acquiring unit 13 configured to acquire a second identification code transmitted from the second wearable electronic device;

a judging unit 14 configured to judge whether the first identification code matches the second identification code, to obtain a judgment result;

an establishing unit 15 configured to establish a connection between the wearable electronic device and the second wearable electronic device when the judgment result indicates that the first identification code matches the second identification code.

Preferably, the wearable electronic device further comprises:

a broadcasting unit 16 configured to broadcast a signal including the first identification code so that the second wearable electronic device can receive the first identification code via wireless communications.

Optionally, the signal may further include request information for requesting establishment of a connection to the second electronic device.

In addition to the above embodiments, the disclosure provides the sixth and the seventh embodiments in the following, in order to solve the technical problem of being unable provide to-be-output information to proper electronic devices for output in a case where a user's multiple electronic devices have established connections therebetween and performed cooperative communications.

It shall be noted that the electronic devices mentioned in the sixth and the seventh embodiments below include wearable electronic devices. Optionally, the electronic devices mentioned below in the sixth and the seventh embodiments include the wearable electronic devices mentioned above in the first to the fifth embodiments.

The general concept of the sixth and the seventh technical solutions is as follows:

An information processing method applicable to a first electronic device is provided. The first electronic device is able to cooperatively communicate with M second electronic devices, where M is an integer greater than or equal to 1. The method comprises:

acquiring to-be-output information;

determining a matching electronic device which satisfies a preset condition, among the first electronic device and the M second electronic devices, so that the to-be-output information can be output by the matching electronic device.

In the technical solutions of these two embodiments, a matching electronic device which satisfies the preset condition is determined, among the first electronic device which receives the to-be-output information and the M second electronic devices which cooperatively communicate with the first electronic device, for outputting the to-be-output information. As such, when one or more electronic devices among the first electronic device and the M second electronic devices which cooperatively communicate with the first electronic device are in a state unsuitable to output the to-be-output information, the first electronic device will not transmit the to-be-output information to the one or more electronic devices. Accordingly, the prior art technical problem of being unable to transmit the to-be-output information to proper electronic devices for output can be effectively solved, and the technical effect of transmitting the to-be-output information to proper electronic devices is achieved.

In the following, detailed description of these two embodiments will be given with reference to Figures. It shall be noted that embodiments of the disclosure and detailed features thereof are given for illustrate rather than limit technical solutions of the disclosure. In case no conflict is incurred, technical features in different embodiments of the disclosure may be combined.

### Sixth Embodiment

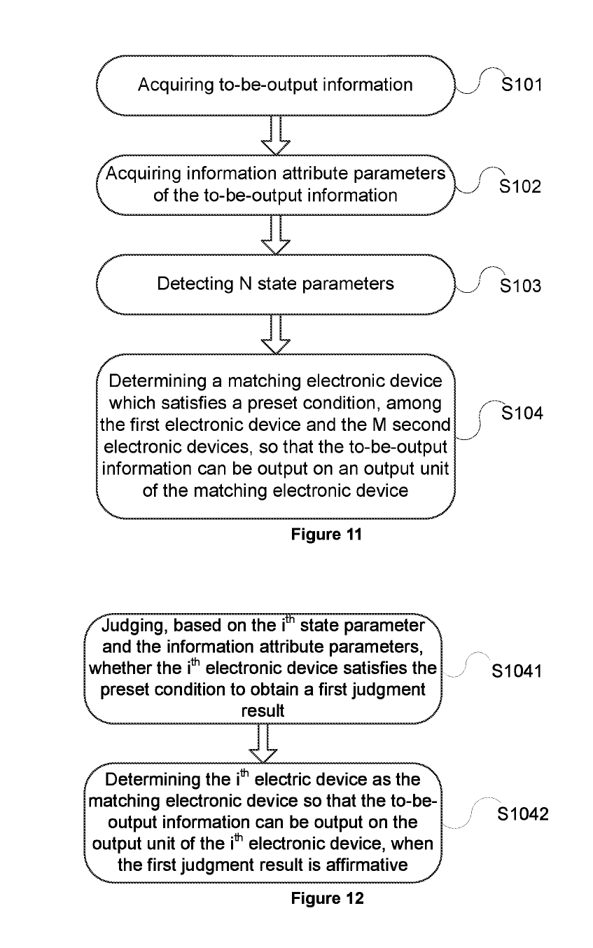

Referring to FIG. 11, the embodiment of the disclosure provides an information processing method applicable to a first electronic device. The first electronic device is able to cooperatively communicate with M second electronic devices, where M is an integer greater than or equal to 1. The method comprises:

At step S101, to-be-output information is acquired.

In detailed implementation, in order to determine a matching electronic device among the first electronic device and the M second electronic devices, the method according to the embodiment of the disclosure comprises the following steps subsequent to step S101.

At step S102, information attribute parameters of the to-be-output information are detected. The information attribute parameters include at least one of a first application parameter of a first application for outputting the to-be-output information, an amount of storage space occupied by the to-be-output information, an output size of the to-be-output information and an amount of power consumption for the to-be-output information.

At step S103, N state parameters are detected. The N state parameters include a first state parameter of the first electronic device and M second state parameters corresponding to the M second electronic devices, where N is a positive integer equal to M+1.

An i^{th} state parameter among the N state parameters is a state parameter of an i^{th} electronic device among N electronic devices including the first electronic device and the M second electronic devices. The i^{th} state parameter includes combination of one or more of the following: at least one application parameter in the i^{th} electronic device, an i^{th} current environment parameter of the i^{th} electronic device and an i^{th} device-inherent parameter of the i^{th} electronic device, where i is any integer between 1 and N.

After the information attribute parameters and the N number of state parameter are obtained by executing steps S102 and S103, the method according to the embodiment of the disclosure may proceed to step S104, where a matching electronic device which satisfies a preset condition is determined, among the first electronic device and the M second electronic devices, so that the to-be-output information can be output by the matching electronic device.

In detailed implementation, the first electronic device may be an electronic device, such as a handset, a tablet computer, a smart watch, a pair of smart glasses, etc. or may be some other electronic device which is not enumerated here. The second electronic devices may be electronic devices, such as handsets, tablet computers, smart watches, smart glasses, etc. or may be other electronic devices which are not enumerated here. The first electronic device can cooperatively communicate with the second electronic devices via data cables, Bluetooth, NFC, WIFI, a mobile communications network or the like.

In the embodiment of the disclosure, a detailed description will be given to explain how the method according to the embodiment of the disclosure is implemented, by taking an example where the first electronic device is a handset, a first one of the second electronic devices is a smart watch and a second one of the second electronic devices is a tablet computer.

In the case of the above example, step S101 may be specifically implemented as follows: when to-be-output information is transmitted to the handset via a network or Bluetooth, the handset acquires the to-be-output information via a detecting module. The to-be-output information may be a picture, an incoming message, video, audio, etc. or may be some other to-be-output information which is not enumerated here.

Again, in the case of the above example, steps S102 and S103 may be specifically implemented as follows:

The handset obtains, via the detecting module, at least one of a first application parameter of a first application for outputting the to-be-output information, an amount of storage space occupied by the to-be-output information, an output size of the to-be-output information and an amount of power consumption for the to-be-output information. For example, when the to-be-output information is a first picture, the handset obtains, via the detecting module, a name of the first application for outputting the picture as “MeiTu XiuXiu (a photo editor)”, an amount of the occupied storage space as 10 M, an output size as 10 cm by 12 cm and an amount of power consumption as 1 mAh. As another example, when the to-be-output information is a first incoming message, the handset obtains, via the detecting module, a name of the first application for outputing the first incoming message as an incoming message application, an amount of the occupied storage space as 50 K, an output size as 3 cm by 4 cm and an amount of power consumption as 0.5 mAh.

The handset at first detects its handset state parameter, which includes combinations of one or more of at least one application parameter of at least one application, a current environment parameter and a device-inherent parameter. For example, the handset detects that the applications in the handset are “MeiTu XiuXiu”, a short message application, an incoming message application, a game application of game A, an audio application, etc., the light intensity in the environment where the handset exists is 700 cd, the screen size of the handset is 5 inch, the power quantity remaining in the handset is 4200 mAh and the amount of the remaining buffer space of the handset is 1.5 G. As another example, the handset only detects that the applications in the handset are “MeiTu XiuXiu”, a short message application, an incoming message application, a game application of game A and an audio application.

By initiating cooperative communications with the smart watch and the tablet computer, the handset may also obtain, via the detecting module, a smart watch state parameter sent from the smart watch and a tablet computer state parameter sent from the tablet computer. The smart watch state parameter includes combinations of one or more of at least one application parameter of at least one application in the smart watch, a current environment parameter and a device-inherent parameter. The tablet computer state parameter includes combinations of one or more of at least one application parameter of at least one application in the tablet computer, a current environment parameter and a device-inherent parameter.

After the above steps are executed, the method according to the embodiment of the disclosure proceeds to step S104, which comprises the following steps.

At step S1041, it is judged, based on the i^{th} state parameter and the information attribute parameters, whether the i^{th} electronic device satisfies the preset condition, to obtain a first judgment result.

At step S1042, the i^{th} electric device is determined as the matching electronic device so that the to-be-output information can be output by the i^{th} electronic device, when the first judgment result is affirmative.

In the embodiment of the disclosure, there are at least three non-limitative implementations of step S1042.

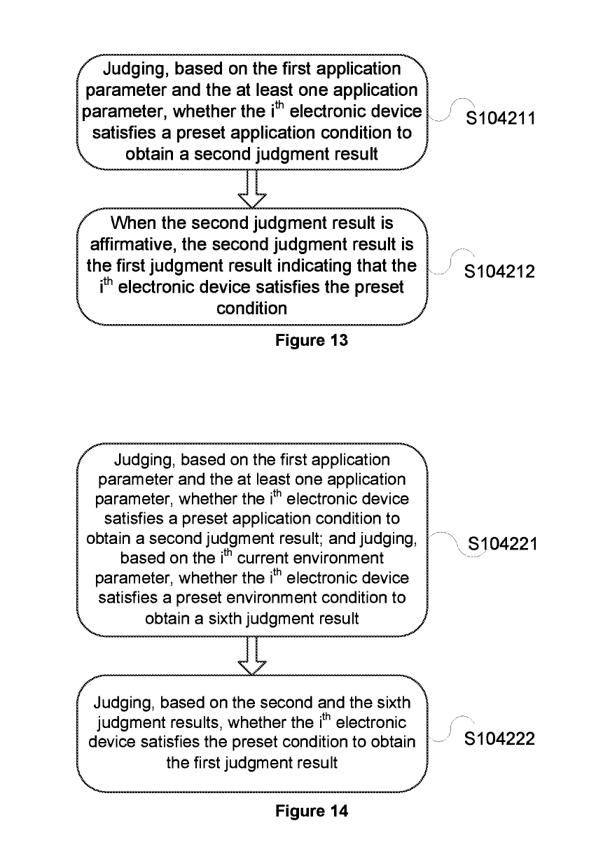

Referring to FIG. 13, in the first implementation, in case the i^{th} state parameter is combination of the at least one application parameter, step S1042 comprises the following steps.

At step S104211, it is judged, based on the first application parameter and the at least one application parameter, whether the i^{th} electronic device satisfies a preset application condition, to obtain a second judgment result.

At step S104212, when the second judgment result is affirmative, the second judgment result is the first judgment result indicating that the i^{th} electronic device satisfies the preset condition.

Specifically, the judging, based on the first application parameter and the at least one application parameter, whether the i^{th} electronic device satisfies the preset application condition to obtain the second judgment result comprises:

obtaining a currently running application in the i^{th} electronic device based on the at least one application parameter;

judging, based on the at least one application parameter and the first application parameter, whether the i^{th} electronic device has the first application installed therein, to obtain a third judgment result;

judging whether the currently running application is an interruptible application, to obtain a fourth judgment result, when the third judgment result is affirmative;

when the fourth judgment result is affirmative, the fourth judgment result is the second judgment result indicating that the i^{th} electronic device satisfies the preset application condition.

When the fourth judgment result is negative, it is judged whether the first application is an application that requires connecting to a network in order to be in a normal running state, to obtain a fifth judgment result.

When the fifth judgment result is negative, the fifth judgment result is the second judgment result indicating that the i^{th} electronic device satisfies the preset application condition; and when the fifth judgment result is affirmative, it indicates that the i^{th} electronic device does not satisfy the preset application condition.

Referring to FIG. 14, in the second implementation, in case the i^{th} state parameter is combination of the at least one application parameter and the i^{th} current environment parameter, step S1042 comprises the following steps.

At step S104221, it is judged, based on the first application parameter and the at least one application parameter, whether the i^{th} electronic device satisfies a preset application condition, to obtain a second judgment result; and it is judged, based on the i^{th} current environment parameter, whether the i^{th} electronic device satisfies a preset environment condition, to obtain a sixth judgment result.

At step S104222, it is judged, based on the second and the sixth judgment results, whether the i^{th} electronic device satisfies the preset condition, to obtain the first judgment result.

When both the second and the sixth judgment results are affirmative, the first judgment result is affirmative indicating that the i^{th} electronic device satisfies the preset condition.

Specifically, the judging, based on the i^{th} current environment parameter, whether the i^{th} electronic device satisfies the preset environment condition to obtain the sixth judgment result comprises:

obtaining a first distance between the i^{th} electronic device and its user and a first light intensity in an environment where the i^{th} electronic device exists, based on the i^{th} environment parameter;

judging whether the first distance is shorter than a first preset distance, to obtain a seventh judgment result;

judging whether the first light intensity is higher than a first preset light intensity, to obtain an eighth judgment result;

judging, based on the seventh and the eighth judgment results, whether the i^{th} electronic device satisfies the preset environment condition, to obtain the sixth judgment result, wherein

when both the seventh and the eighth judgment results are affirmative, the sixth judgment result is affirmative indicating that the i^{th} electronic device satisfies the preset environment condition.

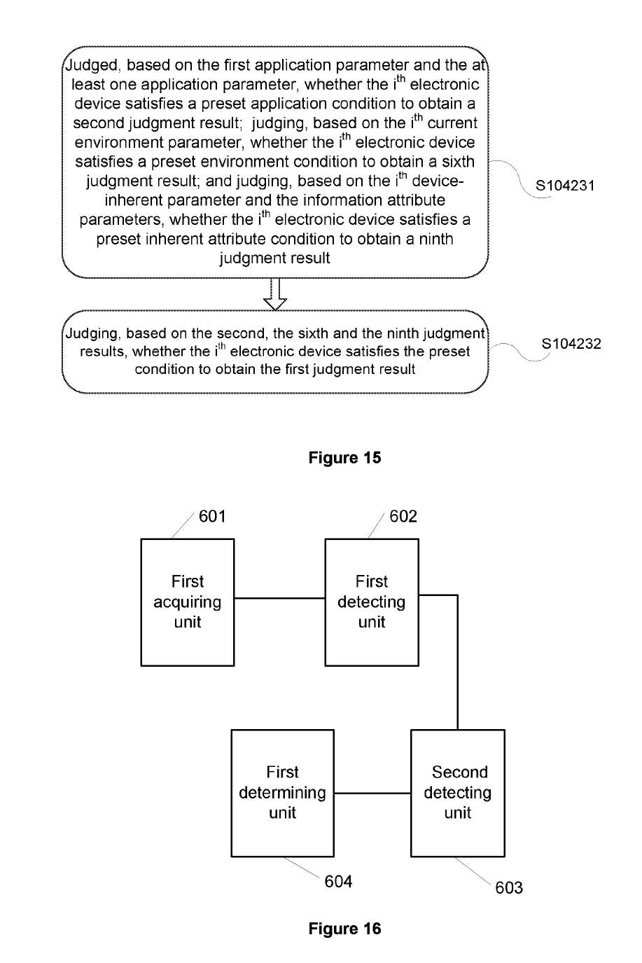

Referring to FIG. 15, in the third implementation, in case the i^{th} state parameter is combination of the at least one application parameter, the i^{th} current environment parameter and the i^{th} device-inherent parameter, step S1042 comprises the following steps.

At step S104231, it is judged, based on the first application parameter and the at least one application parameter, whether the i^{th} electronic device satisfies a preset application condition, to obtain a second judgment result; it is judged, based on the i^{th} current environment parameter, whether the i^{th} electronic device satisfies a preset environment condition, to obtain a sixth judgment result; and it is judged, based on the i^{th} device-inherent parameter and the information attribute parameters, whether the i^{th} electronic device satisfies a preset inherent attribute condition, to obtain a ninth judgment result.

At step S104232, it is judged, based on the second, the sixth and the ninth judgment results, whether the i^{th} electronic device satisfies the preset condition, to obtain the first judgment result.

When all the second, the sixth and the ninth judgment results are affirmative, the first judgment result is affirmative indicating that the i^{th} electronic device satisfies the preset condition.

Specifically, the judging, based on the i^{th} device-inherent parameter and the attribute parameters, whether the i^{th} electronic device satisfies the preset inherent attribute condition to obtain the ninth judgment result comprises:

obtaining a current power quantity, an amount of remaining buffer space and a size of an output unit of the i^{th} electronic device, based on the i^{th} device-inherent parameter;

judging whether the current power quantity is higher than the amount of power consumption, to obtain a tenth judgment result;

judging whether the amount of the remaining buffer space is larger than the amount of the occupied storage space, to obtain an eleventh judgment result;

judging whether the size of the output unit is larger than the output size, to obtain a twelfth judgment result;

judging, based on the tenth, the eleventh and the twelfth judgment results, whether the i^{th} electronic device satisfies the preset inherent attribute condition, to obtain the ninth judgment result, wherein

when all the tenth, the eleventh and the twelfth judgment results are affirmative, the ninth judgment result is affirmative indicating that the i^{th} electronic device satisfies the preset inherent attribute condition.

Again, in the case of the above example where the first electronic device is a handset, a first one of the second electronic devices is a smart watch and a second one of the second electronic devices is a tablet computer, these three implementations of step S1042 are as follows.

In the first implementation, the i^{th} electronic device, which may be a handset, a smart watch or a tablet computer, is determined as a tablet computer and the state parameter of the tablet computer is at least one application parameter in the tablet computer. The handset at first obtains a first application parameter for outputting the to-be-output information, the at least one application parameter in the tablet computer and a currently running application. Then, the handset judges whether the tablet computer has the first application for outputting the to-be-output information installed therein. For example, when the to-be-output information is a first video and the corresponding first application for outputting the first video is “Baidu Videos”, the handset judges whether the application “Baidu Videos” is installed in the tablet computer.

When the tablet computer has the first application installed therein, it is judged whether the application currently running in the tablet computer is an interruptible application. For example, if the application currently running in the tablet computer is “Ebooks” which can run in the background and can save the current reading state while running in the background, it can be judged that “Ebooks” is an interruptible application. As another example, the application currently running in the tablet computer is “QQ games” and the game “Fight the landlord (a Chinese Poker game)” is being played. Because “QQ games”, when interrupted, does not save the user's state information during the interruption, it can be judged that “QQ games” is an uninterruptible application. When the currently running application is an interruptible application, it indicates that the tablet computer satisfies the preset application condition.

When the currently running application is an uninterruptible application, it is judged whether the first application is an application that requires connecting to a network in order to be in a normal running state. If the first application is not an application that requires connecting to a network in order to be in a normal running state, the tablet computer satisfies the preset application condition. Otherwise, the first tablet computer does not satisfy the preset application condition. For example, the first application is a mail application which requires connecting to a network in order to be in a normal running state. In case the application currently running in the tablet computer is “QQ games” and the game “Fight the landlord” is being played, running the mail application would cause an interruption of “QQ games”. Thus, the tablet computer does not satisfy the preset application condition. As another example, the first application is an audio application which is able to work without connecting to a network. In case the application currently running in the tablet computer is “QQ games” and the game “Fight the landlord” is being played, running the audio application would not cause an interruption of “QQ games”. Thus, the tablet computer satisfies the preset application condition. When the tablet satisfies the preset application condition, it indicates that the tablet computer satisfies the preset condition and is a matching electronic device.

In the second implementation, the i^{th} electronic device, which may be a handset, a smart watch or a tablet computer, is determined as a smart watch and the state parameter of the smart watch is at least one application parameter in the smart watch and a current environment parameter of the smart watch. The handset judges whether the smart watch satisfies a preset application condition and a preset environment condition.

In detailed implementation, the handset judges whether the smart watch satisfies the preset application condition in the same manner as is described for judging whether the tablet computer satisfies the preset application condition in the first implementation. The handset judges whether the smart watch satisfies the preset environment condition in the following manner. First, by initiating cooperative communications, the handset obtains a first distance between the smart watch and its user and a first light intensity in an environment where the smart watch exists, which are sent from the smart watch. Then, the handset judges whether the first distance is shorter than a first preset distance and whether the first light intensity is higher than a first preset light intensity. When the first distance is shorter than the first preset distance and the first light intensity is higher than the first preset light intensity, the smart watch satisfies the preset environment condition. For example, when the first preset distance is 50 cm and the first preset light intensity is 2000 cd, the smart watch detects, via a distance detecting module, that the first distance between the smart watch and its user is 0 cm (that is, the smart watch is being worn on the user's wrist) and detects, via a light intensity detecting module, that the light intensity in the environment where the smart watch exists is 2700 cd (that is, without any veil on its surface, the smart watch is visible). The smart watch sends the first distance 0 cm and the first light intensity 2700 cd to the handset. After the handset receives the first distance 0 cm and the first light intensity 2700 cd, it judges that the first distance 0 cm is shorter than the first preset distance 50 cm and the first light intensity 2700 cd is higher than the first preset light intensity 2000 cd. Thus, the smart watch satisfies the preset environment condition.

When the smart watch satisfies both the preset application condition and the preset environment condition, it indicates that the smart watch satisfies the preset condition and is a matching electronic device.

In the third implementation, the i^{th} electronic device, which may be a handset, a smart watch or a tablet computer, is determined as a smart watch and the state parameter of the smart watch is at least one application parameter in the smart watch, a current environment parameter of the smart watch and a device-inherent parameter of the smart watch. The handset judges whether the smart watch satisfies a preset application condition, a preset environment condition and a preset inherent attribute condition.

In detailed implementation, the handset judges whether the smart watch satisfies the preset application condition in the same manner as is described for judging whether the tablet computer satisfies the preset application condition in the first implementation, and judges whether the smart watch satisfies the preset environment condition in the same manner as is described for judging whether the smart watch satisfies the preset environment condition in the second implementation.

In detailed implementation, the handset judges whether the smart watch satisfies the preset inherent attribute condition in the following manner. First, by initiating cooperative communications, the handset obtains a current power quantity, an amount of remaining buffer space and a size of an output unit, which are sent from the smart watch. The handset also obtains the amount of occupied storage space, the output size and the amount of power consumption for the to-be-output information. Then, the handset judges whether the current power quantity of the smart watch is higher than the amount of power consumption for the to-be-output information, whether the amount of the remaining buffer space of the smart watch is larger than the amount of storage space occupied by the to-be-output information, and whether the size of the output unit of the smart watch is larger than the output size of the to-be-output information. When the current power quantity of the smart watch is higher than the amount of power consumption for the to-be-output information, the amount of the remaining buffer space of the smart watch is larger than the amount of storage space occupied by the to-be-output information and the size of the output unit of the smart watch is larger than the output size of the to-be-output information, it indicates that the smart watch satisfies the preset inherent attribute condition.

For example, when the handset detects that the to-be-output information is a picture, for which the amount of occupied storage space is 10 M, the output size is 4 inch and the amount of power consumption is 5 mAh, the handset by initiating cooperative communications obtains the current power quantity of the smart watch as 400 mAh, the amount of the remaining buffer space as 100 M and the size of the output unit as 3 inch, which are sent from the smart watch. Since the current power quantity of the smart watch 400 mAh is higher than the amount of power consumption for the to-be-output information 5 mAh and the amount of the remaining buffer space of smart watch 100 M is larger than the amount of storage space occupied by the to-be-output information 10 M but the size of the output unit of the smart watch 3 inch is smaller than the output size of the to-be-output information 4 inch, the smart watch does not satisfy the preset inherent attribute condition.

As another example, when the handset detects that the to-be-output information is an incoming message, for which the amount of occupied storage space is 0.5 M, the output size is 2 inch and the amount of power consumption is 5 mAh, the handset by initiating cooperative communications obtains the current power quantity of the smart watch as 400 mAh, the amount of the remaining buffer space as 100 M and the size of the output unit as 3 inch, which are sent from the smart watch. Since the current power quantity of the smart watch 400 mAh is higher than the amount of power consumption for the to-be-output information 5 mAh, the amount of the remaining buffer space of smart watch 100 M is larger than the amount of storage space occupied by the to-be-output information 0.5 M and the size of the output unit of the smart watch 3 inch is larger than the output size of the to-be-output information 2 inch, the smart watch satisfies the preset inherent attribute condition.

When the smart watch satisfies all the preset application condition, the preset environment condition and the preset inherent attribute condition, it indicates that the smart watch satisfies the preset condition and is a matching device.

In order to output the to-be-output information by the matching electronic device, after step S104 is executed, the method according to the embodiment of the disclosure proceeds to the following steps:

judging whether the matching electronic device is a third electronic device different from the first electronic device, to obtain a thirteenth judgment result;

transmitting the to-be-output information to the third electronic device so that the to-be-output information can be output by the matching electronic device, when the thirteenth judgment result is affirmative,

Again, by taking the above example where the first electronic device is a handset, a first one of the second electronic devices is a smart watch and a second one of the second electronic devices is a tablet computer, the implementation of the above step is described as follows. When the handset determines that the matching electronic device is a smart watch, it transmits the to-be-information to the smart watch, so that the to-be-output information can be output by the smart watch. Likewise, when the handset determines that the matching electronic device is a tablet computer, it transmits the to-be-output information to the tablet computer, so that the to-be-output information can be output by the tablet computer. When the matching electronic device is just the handset, the to-be-output information is output by the handset.

### Seventh Embodiment

Referring to FIG. 16, based on the same concept as the method according to the sixth embodiment of the disclosure, the embodiment of the disclosure also provides a first electronic device. The first electronic device is able to cooperatively communicate with M second electronic devices, where M is an integer greater than or equal to 1. The electronic device comprises:

a first acquiring unit 601 configured to acquire to-be-output information;

a first detecting unit 602 configured to detect information attribute parameters of the to-be-output information, wherein the information attribute parameters include at least one of a first application parameter of a first application for outputting the to-be-output information, an amount of storage space occupied by the to-be-output information, an output size of the to-be-output information and an amount of power consumption for the to-be-output information;

a second detecting unit 603 configured to detect N state parameters which include a first state parameter of the first electronic device and M second state parameters corresponding to the M second electronic devices, where N is a positive integer equal to M+1,

wherein an i^{th} state parameter among the N state parameters is a state parameter of an i^{th} electronic device among N electronic devices including the first electronic device and the M second electronic devices, and includes combination of one or more of the following: at least one application parameter in the i^{th} electronic device, an i^{th} current environment parameter of the i^{th} electronic device and an i^{th} device-inherent parameter of the i^{th} electronic device, where i is any integer between 1 and N;

a first determining unit 604 configured to determine a matching electronic device which satisfies a preset condition, among the first electronic device and the M second electronic devices, so that the to-be-output information can be output by the matching electronic device.

In order to determine the matching electronic device which satisfies the preset condition, the first electronic device comprises:

a first judging subunit configured to judge, based on the i^{th} state parameter and the information attribute parameters, whether the i^{th} electronic device satisfies the preset condition, to obtain a first judgment result;

a first determining subunit configured to determine the i^{th} electric device as the matching electronic device so that the to-be-output information can be output by the i^{th} electronic device, when the first judgment result is affirmative.

In case the i^{th} state parameter is combination of the at least one application parameter, the first judging subunit comprises:

a first judging module configured to judge, based on the first application parameter and the at least one application parameter, whether the i^{th} electronic device satisfies a preset application condition, to obtain a second judgment result, wherein

when the second judgment result is affirmative, the second judgment result is the first judgment result indicating that the i^{th} electronic device satisfies the preset condition.

Specifically, the first judging module comprises:

a first obtaining submodule configured, to obtain a currently running application in the i^{th} electronic device based on the at least one application parameter;

a first judging submodule configured to judge, based on the at least one application parameter and the first application parameter, whether the i^{th} electronic device has the first application installed therein, to obtain a third judgment result;

a second judging submodule configured to judge whether the currently running application is an interruptible application, to obtain a fourth judgment result, when the third judgment result is affirmative, wherein

when the fourth judgment result is affirmative, the fourth judgment result is the second judgment result indicating that the i^{th} electronic device satisfies the preset application condition;

a third judging submodule configured to judge whether the first application is an application that requires connecting to a network in order to be in a normal running state, to obtain a fifth judgment result, when the fourth judgment result is negative, wherein

when the fifth judgment result is negative, the fifth judgment result is the second judgment result indicating that the i^{th} electronic device satisfies the preset application condition; and when the fifth judgment result is affirmative, it indicates that the i^{th} electronic device does not satisfy the preset application condition.

In case the i^{th} state parameter is combination of the at least one application parameter and the i^{th} current environment parameter, the first judging subunit comprises:

a first judging module configured to judge, based on the first application parameter and the at least one application parameter, whether the i^{th} electronic device satisfies a preset application condition, to obtain a second judgment result;

a second judging module configured to judge, based on the i^{th} current environment parameter, whether the i^{th} electronic device satisfies a preset environment condition, to obtain a sixth judgment result;

a third judging module configured to judge, based on the second and the sixth judgment results, whether the i^{th} electronic device satisfies the preset condition, to obtain the first judgment result, wherein

when both the second and the sixth judgment results are affirmative, the first judgment result is affirmative indicating that the i^{th} electronic device satisfies the preset condition.

Specifically, the second judging module comprises:

a second obtaining submodule configured, to obtain a first distance between the i^{th} electronic device and its user and a first light intensity in an environment where the i^{th} electronic device exists, based on the i^{th} environment parameter;

a fourth judging submodule configured to judge whether the first distance is shorter than a first preset distance, to obtain a seventh judgment result;

a fifth judging submodule configured to judge whether the first light intensity is higher than a first preset light intensity, to obtain an eighth judgment result;

a sixth judging submodule configured to judge, based on the seventh and the eighth judgment results, whether the i^{th} electronic device satisfies the preset environment condition, to obtain the sixth judgment result, wherein

when both the seventh and the eighth judgment results are affirmative, the sixth judgment result is affirmative indicating that the i^{th} electronic device satisfies the preset environment condition.

In case the i^{th} state parameter is combination of the at least one application parameter, the i^{th} current environment parameter and the i^{th} device-inherent parameter, the first judging subunit comprises:

a first judging module configured to judge, based on the first application parameter and the at least one application parameter, whether the i^{th} electronic device satisfies a preset application condition, to obtain a second judgment result;

a second judging module configured to judge, based on the i^{th} current environment parameter, whether the i^{th} electronic device satisfies a preset environment condition, to obtain a sixth judgment result;

a fourth judging module configured to judge, based on the i^{th} device-inherent parameter and the information attribute parameters, whether the i^{th} electronic device satisfies a preset inherent attribute condition, to obtain a ninth judgment result;

a fifth judging module configured to judge, based on the second, the sixth and the ninth judgment results, whether the i^{th} electronic device satisfies the preset condition, to obtain the first judgment result, wherein

when all the second, the sixth and the ninth judgment results are affirmative, the first judgment result is affirmative indicating that the i^{th} electronic device satisfies the preset condition.

Specifically, the fourth judging module comprises:

a third obtaining submodule configured to obtain a current power quantity, an amount of remaining buffer space and a size of an output unit of the i^{th} electronic device, based on the i^{th} device-inherent parameter;

a seventh judging submodule configured to judge whether the current power quantity is higher than the amount of power consumption, to obtain a tenth judgment result;

an eighth judging submodule configured to judge whether the amount of the remaining buffer space is larger than the amount of the occupied storage space, to obtain an eleventh judgment result;

a ninth judging submodule configured to judge whether the size of the output unit is larger than the output size, to obtain a twelfth judgment result;

a tenth judging submodule configured to judge, based on the tenth, the eleventh and the twelfth judgment results, whether the i^{th} electronic device satisfies the preset inherent attribute condition, to obtain the ninth judgment result, wherein

when all the tenth, the eleventh and the twelfth judgment results are affirmative, the ninth judgment result is affirmative indicating that the i^{th} electronic device satisfies the preset inherent attribute condition.

In order to output the to-be-output information by the matching electronic device, the first electronic device further comprises:

a first judging unit configured to judge whether the matching electronic device is a third electronic device different from the first electronic device, to obtain a thirteenth judgment result;

a first transmitting unit configured to transmit the to-be-output information to the third electronic device so that the to-be-output information can be output by the matching electronic device, when the thirteenth judgment result is affirmative.

As those skilled in the art will appreciate, the embodiments of the disclosure may be provided as methods, systems or computer program products. Thus, the disclosure may be embodied as pure hardware, pure software or a combination of software and hardware. In addition, the disclosure may be embodied as computer program products that are implemented on one or more computer-readable storage mediums (including but not limited to magnetic disk storage, CD-ROM, optical storage, etc.) containing computer-readable program codes.

The disclosure is described by referring to flowcharts and/or block diagrams of the methods, devices (systems) and computer program products according to the embodiments of the disclosure. It shall be understood that each flow and/or block in the flowcharts and/or block diagrams or a combination of flows and/or blocks in the flowcharts and/or block diagrams may be implemented by computer program instructions. These computer program instructions may be provided to a general-purpose computer, a specific-purpose computer, an embedded processor or some other programmable data processing device to create a machine, so that the instructions, which are executed by the processor of the computer or the programmable data processing device, create a device for realizing functions specified in one or more flows in the flowcharts and/or one or more blocks in the block diagrams.

The computer program instructions may also be stored in a computer-readable storage that can direct a computer or some other programmable data processing device to work in a specific manner, so that the instructions stored in the computer-readable storage create a manufactured product which comprises instruction means for realizing functions specified in one or more flows in the flowcharts and/or one or more blocks in the block diagrams.

The computer program instructions may also be loaded on a computer or some other programmable data processing device, so that a series of operations are executed on the computer or the programmable data processing device to generate computer-implemented processes. As such, the instructions executed on the computer or the programmable data processing device provide steps for realizing functions specified in one or more flows in the flowcharts and/or one or more blocks in the block diagrams.

To be specific, computer program instructions which correspond to the information processing method according to the embodiment of the disclosure may be stored on a storage medium such as an optical disc, a hard disk, a USB disk, etc. When the computer program instructions in the storage medium which correspond to the information processing method according to the embodiment of the disclosure are read or executed by a first electronic device, information processing methods according to the above aspects are performed.

As those skilled in the art will appreciate, the functions of the processing units in the wearable electronic device according to the embodiment of the disclosure may be understood by referring to related description of the above-described information processing method. The processing units in the embodiment of the disclosure may be implemented by using analogous circuits that enable the functions described in the embodiment of the disclosure or by running software that enables the functions described in the embodiment of the disclosure on a smart device.

In case no conflict is incurred, technical solutions according to different embodiments of the disclosure may be combined arbitrarily.

It shall be understood that the methods and smart devices disclosed by the embodiments of the disclosure may be implemented in other manners. The device embodiments described above are just illustrative. For example, although devices are divided into units in terms of logical function, they may be divided in other manners in practical implementation. For example, multiple units or components may be combined or integrated into another system, or some features may be omitted or may not be implemented. In addition, couplings, direct couplings or communication connections between the illustrated or described components may be accomplished through the use of some interfaces. Indirect couplings or communication connections between devices or units may be in an electrical form, a mechanical form or some other form.

The units described above as discrete components may or may not be separate physically. Components shown as units may or may not be physical units. That is, the components may be located at the same place, or may be distributed over multiple network units. According to practical demands, part or all of the units may be chosen for implementing the technical solutions according to the embodiments of the disclosure.

In addition, the function units in the embodiments of the disclosure may be all together integrated into a second processing unit. Alternatively, each unit may exist as a single unit, or two or more units may be integrated into a single unit. The integrated unit may be implemented as hardware or as hardware plus software function units.

Although preferable embodiments of the disclosure have been described, those skilled in the art may make various alterations and changes to the embodiments upon realizing the fundament inventive concept. Therefore, the claims appended below are intended to be interpreted as encompassing the preferable embodiments as well as all alterations and changes that fall within the scope of the disclosure.

Obviously, those skilled in the art may make various alterations and changes to the disclosure without departing from the spirit and scope thereof. Thus, if these alterations and changes fall within the scope of the claims and the technical equivalents thereof, they are intended to be covered by the disclosure.

1. An information processing method applicable to a first wearable electronic device, wherein the first wearable electronic device is able to maintain a first relative positional relationship with a first part of a user, the information processing method comprising:
obtaining a first physiological parameter at the first part of the user by using the first wearable electronic device;
generating a first identification code corresponding to the first physiological parameter;
acquiring a second identification code transmitted from a second wearable electronic device which communicates with the first wearable electronic device;
judging whether the first identification code matches the second identification code, to obtain a judgment result; and
establishing a connection between the first wearable electronic device and the second wearable electronic device, if the judgment result indicates that the first identification code matches the second identification code.

2. The information processing method according to claim 1, wherein the acquiring the second identification code transmitted from the second wearable electronic device comprises:
acquiring the second identification code generated according to a second physiological parameter, wherein the second physiological parameter is obtained by the second wearable electronic device at the second part of the user.

3. The information processing method according to claim 1, further comprising:
presetting a physiological parameter database storing at least one physiological parameter of N users, where N≧1,
wherein the judging whether the first identification code matches the second identification code comprises:
judging, according to the physiological parameter database, whether the first physiological parameter corresponding to the first identification code and the second physiological parameter corresponding to the second identification code are from the same user, to obtain a judgment result; and
determining that the first identification code matches the second identification code, if the judgment result indicates that the first physiological parameter corresponding to the first identification code and the second physiological parameter corresponding to the second identification code are from the same user.

4. The information processing method according to claim 1, further comprising:
presetting a physiological parameter database storing at least one physiological parameter of N users, where N≧1,
wherein the judging whether the first identification code matches the second identification code comprises:
judging, according to the physiological parameter database, whether the first physiological parameter corresponding to the first identification code and the second physiological parameter corresponding to the second identification code are stored in the physiological parameter database, to obtain a judgment result; and
determining that the first identification code matches the second identification code, when the judgment result indicates that the first physiological parameter corresponding to the first identification code and the second physiological parameter corresponding to the second identification code are stored in the physiological parameter database.

5. A wearable electronic device that is able to perform information interaction with at least one wearable electronic device including a second wearable electronic device, wherein the wearable electronic device is able to maintain a first relative positional relationship with a first part of a user, and the second wearable electronic device is able to maintain a second relative positional relationship with a second part of the user, the wearable electronic device comprising:
an obtaining unit configured to obtain a first physiological parameter at the first part of the user;
a generating unit configured to generate a first identification code corresponding to the first physiological parameter;
an acquiring unit configured to acquire a second identification code transmitted from the second wearable electronic device;
a judging unit configured to judge whether the first identification code matches the second identification code, to obtain a judgment result; and
an establishing unit configured to establish a connection between the wearable electronic device and the second wearable electronic device if the judgment result indicates that the first identification code matches the second identification code.

6. The wearable electronic device according to claim 5, wherein the acquiring unit is configured to acquire the second identification code generated according to a second physiological parameter, wherein the second physiological parameter is obtained by the second wearable electronic device at the second part of the user.

7. The wearable electronic device according to claim 5, further comprising:
a setting unit configured to preset a physiological parameter database storing at least one physiological parameter of N users, where N≧1,
wherein the judging unit comprises:
a first judging subunit configured to judge, according to the physiological parameter database, whether the first physiological parameter corresponding to the first identification code and the second physiological parameter corresponding to the second identification code are from the same user, to obtain a judgment result; and
a first determining subunit configured to determine that the first identification code matches the second identification code, if the judgment result indicates that the first physiological parameter corresponding to the first identification code and the second physiological parameter corresponding to the second identification code are from the same user.

8. The wearable electronic device according to claim 5, further comprising:
a setting unit configured to preset a physiological parameter database storing at least one physiological parameter of N users, where N≧1,
wherein the judging unit comprises:
a second judging subunit configured to judge, according to the physiological parameter database, whether the first physiological parameter corresponding to the first identification code and the second physiological parameter corresponding to the second identification code are stored in the physiological parameter database, to obtain a judgment result; and
a second determining subunit configured to determine that the first identification code matches the second identification code, if the judgment result indicates that the first physiological parameter corresponding to the first identification code and the second physiological parameter corresponding to the second identification code are stored in the physiological parameter database.

9-20. (canceled)
